(19) United States
(12) Patent Application Publication
(10) Pub. No.: US 2002/0194037 A1
(43) Pub. Date: Dec. 19, 2002

(54) Method and apparatus for arranging flexible and cost-efficient private air travel

(76) Inventors: Jeff Creed, Duxbury, MA (US); Paul A. Svensen, Scituate, MA (US); John I. Williams, Jamaica Plain, MA (US); Tolga Erdogus, Harvard, MA (US)

Correspondence Address: BROMBERG & SUNSTEIN LLP, 125 SUMMER STREET, BOSTON, MA, 02110-1618, US

(21) Appl. No.: 10/087,039

(22) Filed: Feb. 28, 2002

Related U.S. Application Data
(63) Continuation of application No. 09/909,413, filed on Jul. 19, 2001.
(60) Provisional application No. 60/219,730, filed on Jul. 19, 2000.
(60) Provisional application No. 60/306,334, filed on Jul. 18, 2001.

(51) Int. Cl. G06F 17/60

(52) U.S. Cl. 705/5

(57) ABSTRACT

A method and system for providing private air travel to a plurality of customers includes establishing a pool of aircraft service providers and obtaining an aircraft service request from each customer. One or more aircraft that conform to each set of customer-specified parameters is selected from the pool of aircraft service providers and matched to the aircraft service request in a manner that minimizes the occurrence of passenger-less flights.

The present application is a continuation of Ser. No. 09/909,413 which is a nonprovisional application filed on Jul. 19, 2001 claiming priority from provisional application Serial No. 60/219,730 which was filed July 19, 2000, and provisional application Serial No. 60/306,334 which was filed July 18, 2001, all of which are hereby incorporated, in their entirety, by reference.

### TECHNICAL FIELD

The present invention relates to air travel, and more particularly, to a method and apparatus for providing flexible, cost efficient private air travel.

### BACKGROUND TO THE INVENTION

Private air travel has conventionally been provided in three different ways. An individual (such as an individual person, business, organization or association) may purchase an aircraft and thus acquire full ownership of the aircraft. An individual may purchase part of an aircraft, a situation commonly referred to as fractional ownership. An individual may also hire or rent an aircraft through a charter company. Each of these situations involves its own cost considerations and use restrictions.

Full ownership includes amortization of aircraft acquisition cost as well as flight crew and maintenance charges. Further direct operating costs include fuel, taxes, catering and landing fees. The individual owner is limited to the use of a dedicated aircraft and ultimately pays for total available aircraft flight hours, whether or not the aircraft is utilized.

In the second situation, buyers purchase a share in an airplane. Generally, shares in a business airplane range from one-sixteenth to one-half of the total price of the plane. The buyer is guaranteed a proportional number of flight hours and charged a per-flight hour fee as well as a monthly maintenance fee. If a buyer exceeds that number of hours, more hours may be purchased at a premium rate. Thus, fractional ownership includes the cost of acquiring the fractional share, a monthly management fee, an hourly rate fee, and a residual fee at the completion of the acquisition term. The share purchased commits the owner to a predetermined annual number of flight hours in a specified aircraft type, regardless of whether the shareowner's needs change, and the owner cannot fly multiple simultaneous missions. Further, response time for a shareowner's flight request is typically at least six hours.

Charter situations include an hourly flight rate and a positioning charge if the passenger or customer is not departing from the charter operator's flight base. Additionally, one-way flights are usually performed at round trip prices because the charter carrier cannot leave an aircraft at a remote location to await the passenger's future return. The customer must locate a charter company that serves the desired destination, the desired aircraft type, or both. A limited charter fleet size often limits service flexibility, hence it is difficult to serve one-way flight requirements. Further, the response time for a customer or passenger's flight request varies drastically depending on the charter carrier, and there are few carriers that operate on a national scale.

### SUMMARY OF THE INVENTION

In accordance with an embodiment of the present invention, a method for providing private air travel to a plurality of customers includes establishing a pool of aircraft service providers and obtaining an aircraft service request from each customer. The aircraft service request includes a set of customer specified parameters relating the customer's flight. One or more aircraft that conform to each set of customer-specified parameters is selected from the pool of aircraft service providers and matched to each aircraft service request, in accordance with the customer-specified parameters, in a manner that minimizes the occurrence of passenger-less flights.

The method may further comprise receiving one or more service requests through a web page, and/or providing a travel card to one or more of the customers wherein the travel card represents a pre-purchased amount of private aircraft service.

In accordance with another embodiment of the invention, a travel card for providing private air travel to a customer includes a first face and a second face, the first face including thereon an identification number for identifying a customer authorized to use the travel card and a designation representing a pre-purchased allotment of private aircraft service. In a related embodiment, the first face or the second face may include thereon a designation representing a pre-determined number of private aircraft service upgrades that are redeemable at the option of the customer. The first face or the second face may also include thereon a magnetic strip that enables the card to be read by a magnetic strip reader. In yet another related embodiment, the travel card may further comprise a processor and a memory disposed between the first face and the second face, and the memory may retain data pertinent to the customer's private aircraft service preferences and/or data pertinent to the customer's medical preferences, medical conditions or catering preferences. The memory may also retain data pertinent to the customer's post-flight or pre-flight travel preferences. In a further related embodiment, the processor may include program code for establishing a communication link to a computer network when the program code is read by a computer, and the network may provide a communication link to a private air travel contractor.

In accordance with another embodiment of the invention, a graphical user interface for providing private air travel to a customer includes a request module, a selection module, and a payment module. The request module provides a request interface containing fields for entering private aircraft travel request information, and the payment module provides a payment interface through which the customer may enter private aircraft travel payment information. The selection module provides a selection interface that displays information regarding the availability of aircraft that satisfy the customer's travel request information. In accordance with a related embodiment, the graphical user interface may also include a tracking module that provides a tracking interface for displaying information regarding a flight status to a customer. In accordance with another related embodiment, the graphical user interface may also include an account module that provides an account interface for displaying information relevant to a private air travel customer's personal account.

In accordance with another embodiment of the invention, a graphical user interface for providing private air travel to a plurality of customers includes a search module that provides an interface whereby a user may locate, in substantially real time, an aircraft that satisfies travel requirements of each customer. The graphical user interface also includes a tracking module that provides an interface whereby the user may track the flight progress of one or more aircraft that may satisfy travel requirements of each customer. In a related embodiment, the graphical user interface may also include a flight entry module that provides an interface containing fields for creating a flight for each customer and generating an interface for displaying a calender of updated flights in accordance with the entry of each flight created. In further related embodiments, the graphical user interface may also include a flight information module that provides an interface for displaying information regarding aircraft availability to the user; a payment module that provides a payment interface containing fields by which a user may enter customer payment information; and/or a report module that provides an interface whereby a user may generate a flight report.

In accordance with another embodiment of the invention, a system for providing private air travel to a plurality of customers includes means for communicating with a plurality of aircraft service providers, the aircraft service providers supplying a plurality of aircraft types from a plurality of locations and means for communicating with each customer, each customer providing an itinerary for private air travel, such that at least one aircraft from the plurality of aircraft service providers is matched to the itinerary in a manner that minimizes the occurrence of passenger-less flights.

In accordance with a further embodiment of the invention, a computer program product for providing a database for providing private air travel to a plurality of customers, the computer program product comprising a computer readable medium having computer code thereon, includes program code for receiving data regarding aircraft provided by at least one satellite dish and at least one computer network, and program code for storing the data provided by the satellite dish and the computer network.

In accordance with a yet another embodiment of the invention, a method for providing private air travel to a plurality of customers includes receiving data relevant to a plurality of aircraft owned by a plurality of aircraft service providers via a first communication link, and receiving data relevant to a plurality of customer service requests via a second communication link. The data received from the first and second communication links is saved to a storage medium and analyzed in order to match at least one aircraft to each customer service request in a manner that minimizes the occurrence of passenger-less flights.

In accordance with another embodiment of the invention, a method for providing travel services including private air travel to a plurality of customers includes providing a pre-purchased allotment of private air travel to one or more of the customers and receiving a travel service request from each customer, wherein the travel service request includes customer-specified flight parameters. The method also includes providing an aircraft that satisfies the customer-specified flight parameters for each customer's travel service request. The value of the travel service is debited from the pre-purchased allotment of private air travel for each customer provided with a pre-purchased allotment.

### BRIEF DESCRIPTION OF THE FIGURES

The foregoing features of the invention will be more readily understood by reference to the following detailed description taken with the accompanying drawings in which:

FIG. 1 is block diagram illustrating a system for providing private air travel in accordance with an embodiment of the present invention;

FIG. 2 is an illustration of a graphical user interface which may be used to provide private air travel in accordance with an embodiment of the invention;

FIG. 3 is an illustration of an aircraft locator interface for conducting a search for aircraft in accordance with another embodiment of the invention;

FIG. 4 is an illustration of an interface by which a user may view the results of the search conducted in accordance with the embodiment of FIG. 3;

FIG. 5 is an illustration of a aircraft location display interface in accordance with the embodiment of FIG. 3;

FIG. 6 is an illustration of airport locator display interface in accordance with the embodiment of FIG. 3;

FIG. 7 is an illustration of a graphical user interface for tracking one or more aircraft in accordance with the embodiment of FIG. 3;

FIG. 8 is an illustration of an interface for viewing the tracked aircraft in accordance the embodiment of FIGS. 3 and 7;

FIG. 9 is an illustration of an interface for viewing tracked aircraft in a particular geographical region accordance with the embodiment of FIGS. 3, 7 and 8;

FIG. 10 is an illustration of a web page providing a graphical user interface to a customer in accordance with another embodiment of the present invention;

FIG. 11 is a graphical illustration of a travel card in accordance with another embodiment of the invention;

FIG. 12 is a flow chart illustrating a method for providing private air travel in accordance with an embodiment of the present invention; FIG. 13 is a flow chart illustrating the method of FIG. 11 detailing pre-flight procedures;

FIG. 14 s a flow chart illustrating the method of FIG. 11 detailing post-flight procedures;

FIG. 15 is an illustration showing login icon on a pull down menu of the flight command center module in accordance with an embodiment of the invention;

FIG. 16 is an illustration showing a login interface in accordance with the icon of FIG. 15;

FIG. 17 is an illustration showing a user password interface of the flight command center module of FIG. 15;

FIG. 18 is an illustration showing a command center application menu of the flight command center module of FIG. 15;

FIG. 19 is an illustration showing navigation bars used in accordance with the flight command center module of FIG. 15;

FIG. 20 is an illustration showing screen view pull down menu of the flight command center module of FIG. 15;

FIG. 21 is an illustration showing a user help pull down menu of the flight command center module of FIG. 15;

FIG. 22 is an illustration showing a customer information pull down menu of the flight command center module of FIG. 15;

FIG. 23 is an illustration showing a customer information interface of the flight command center module of FIG. 15;

FIG. 24 is an illustration showing a customer search interface of the flight command center module of FIG. 15;

FIG. 25 is an illustration showing a customer action detail interface of a flight command center module of FIG. 15;

FIG. 26 is an illustration showing a customer action interface of the flight command center module of FIG. 15;

FIG. 27 is an illustration showing a customer preferences interface of the flight command center module of FIG. 15;

FIG. 28 is an illustration showing a customer references interface of the flight command center module of FIG. 15;

FIG. 29 is an illustration showing a complimentary upgrade report interface of the flight command center module of FIG. 15;

FIG. 30 is an illustration showing an options pull down menu of the flight command center module of FIG. 15;

FIG. 31 is an illustration showing a travel card information interface of the flight command center module of FIG. 15;

FIG. 32 is an illustration showing a travel card/customer balance information interface of the flight command center module of FIG. 15;

FIG. 33 is an illustration showing a travel card referral interface of the flight command center module of FIG. 15;

FIG. 34 is an illustration showing an aircraft information interface of the flight command center module of FIG. 15;

FIG. 35 is an illustration showing an aircraft photograph interface of the flight command center module of FIG. 15;

FIG. 36 is an illustration showing an aircraft feedback interface of the flight command center module of FIG. 15;

FIG. 37 is an illustration showing an aircraft search interface of a search and notification module associated with the flight command center module of FIG. 15;

FIG. 38 is an illustration showing a display by which a user may view the results of a search conducted using the search interface of FIG. 37;

FIG. 39 is an illustration showing an airport information interface of the flight command center module of FIG. 15;

FIG. 40 is an illustration showing an airport locator interface of the flight command center module of FIG. 15;

FIG. 41 is an illustration showing an aircraft service provider information interface of the flight command center module of FIG. 15;

FIG. 42 is an illustration showing an aircraft service provider search interface of the flight command center module of FIG. 15;

FIG. 43 is an illustration showing an address/city selection interface of the flight command center module of FIG. 15;

FIG. 44 is an illustration showing a flight information pull down menu of the flight command center module of FIG. 15;

FIG. 45 is an illustration showing a flight worksheet interface of the flight command center module of FIG. 15;

FIG. 46 is an illustration showing flight report interface of the flight command center module of FIG. 15;

FIG. 47 is an illustration showing a month view of a flight calendar interface of the flight command center module of FIG. 15;

FIG. 48 is an illustration showing week view of the flight calendar interface of FIG. 47;

FIG. 49 is an illustration showing a day view of the flight calendar interface FIG. 47;

FIG. 50 is an illustration showing a grid view of the flight calendar interface of FIG. 47;

FIG. 51 is an illustration showing a flight calendar filter interface associated with the flight calendar interface of FIG. 47; and

FIG. 52 is an illustration showing an option menu associated with the flight calendar interface of FIG. 47.

### DETAILED DESCRIPTION OF SPECIFIC EMBODIMENTS

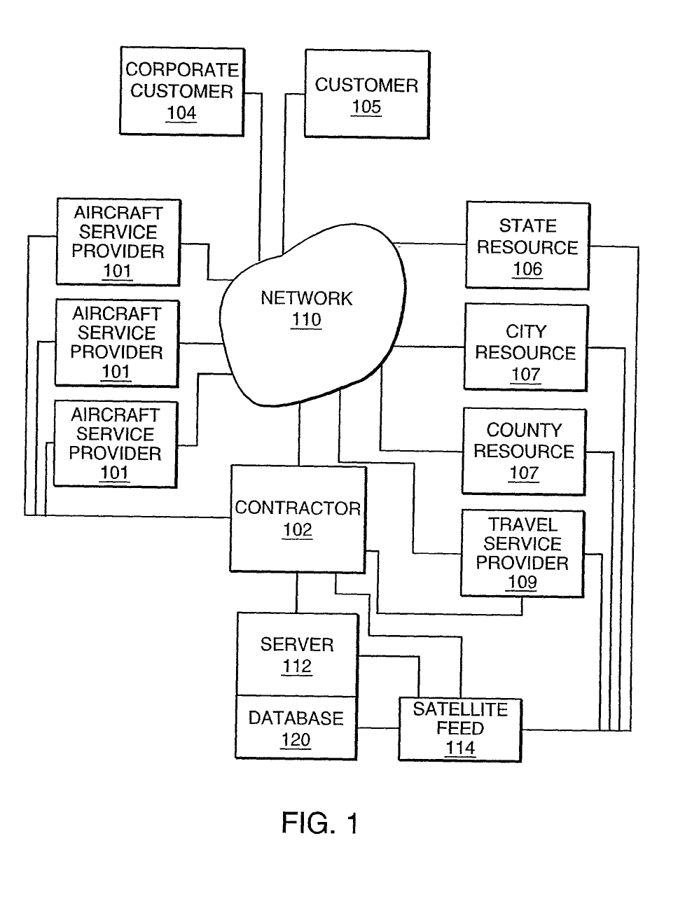

FIG. 1 is block diagram illustrating a system for providing private air travel in accordance with an embodiment of the present invention. The system includes a plurality of aircraft service providers 101 in communication with a private air travel contractor 102. (As used herein, a “contractor” refers to the entity providing or arranging the private air travel to the customer and engaging services from the aircraft service providers. Additionally, an “aircraft service provider” may be a charter company or an aircraft owner. In certain embodiments of the invention, an aircraft service provider may be referred to as a “carrier”.) The aircraft service providers 101 supply a variety of aircraft types which may travel to and from any number of locations both nationally and internationally. The private air travel contractor 102 is in communication with a plurality of customers, such as customers 104 and 105, via a network 110. The network 110 may include a Wide Area Network (WAN), such as the Internet, a System Area Network (SAN), or a Local Area Network (LAN) such as a CAT 5 certified LAN. The customers 104, 105 may communicate with the contractor 102 via the network and an electronic link established by program code resident on a processor contained in a travel card provided by the contractor 102. Similarly, the customers 104, 105 may communicate with the contractor 102 via facsimile, e-mail, web-page, telephone, or in person. The private air travel contractor 102 matches at least one aircraft from at least one of the plurality of aircraft service providers 101 to a private air travel request from each customer 104 and 105 in accordance with a set of customer-specified parameters that are provided by the customers 104 and 105 in a manner that minimizes the occurrence of passenger-less flights, as will be described in greater detail below.

The contractor 102 may choose from a plurality of different aircraft types and sizes (such as turbo prop aircraft, light jet aircraft, a mid-size jet aircraft, or a heavy jet aircraft) in accordance with the customer's requirements or preferences, and the aircraft may be automatically upgraded to a different size or type at a later time. The contractor 102 may also be in communication with other travel service providers 109 to provide each customer 104, 105 with, for example, ground transportation (e.g., car rental services, taxi services, private bus services and train services), boat and ferry services, and hotel or motel or other travel accommodations.

In order to minimize the occurrence of passenger-less flights, the contractor 102 has access to one or more databases 120, which may be resident on one or more database servers 112. Similarly, the database 120 may be accessed through the network 110. The database 120, under appropriate program control, receives real time and batch mode data from a plurality of disparate sources. These sources include, but are not limited to, the aircraft service providers 101, individual aircraft, airports, travel services providers 109, city resources 107, state resources 106, and country resources 108. The contractor 102 is also in communication with one or more satellite dishes 114, either directly or through the database 120 or server 112.

Data received from these sources includes, but is not limited to: information pertinent to flight statuses (active flights, proposed flights, landed flights, one-way flights and transient flights); information regarding aircraft types; information regarding time zones; information regarding aircraft safety and maintenance histories; information regarding aircraft service provider safety history; information regarding pilot safety and training histories; and information regarding pre-flight or post-flight travel arrangements and accommodations.

In accordance with one embodiment of the invention, data is obtained from the various sources using software programs such as those provided by Microsoft®, Inc., Air Charter Guide™ (ACG), RLM Software, Inc. and ARGUS, Inc. For example, a contractor 102 may use a standardized Microsoft® Windows 2000® (operating system for all server and workstations associated with the contractor's business. Data feeds for active, proposed, and landed flights may come from third party applications that may use Windows NT™. The RLM software provides the contractor 102 (either directly, or through the database 120 and/or database server 112) with a communication link to one or more satellite dishes such that information regarding the position of all aircraft with recorded or filed flight plans is updated every three minutes. The positioning information may include the tail number associated with an aircraft, the origin and destination airports associated with an aircraft, the departure and arrival time associated with an aircraft, the longitude and latitude associated with an aircraft and a last known status associated with an aircraft.

The ACG software provides the contractor 102 with a communication to the Internet such that information relevant to aircraft availability (particularly with respect to one-way and transient flights) is updated every hour. As used herein a “transient” aircraft refers to a flight or aircraft that is landed at an aircraft base that is not its home base. A transient aircraft is waiting to be scheduled for a flight destined for the aircraft's home base. The ACG software also provides the contractor 102 with “on demand” information about aircraft, airports and service providers, as will be described in greater detail below.

The ARGUS software provides the contractor 102 with a communication link to the Internet, supplied on demand, such that information regarding quality inspection ratings for aircraft service providers and aircraft may be obtained. Information obtained utilizing such software devices may be stored in the database 120 via the contractor, or the information may be delivered directly to the database server 112 from external sources for storage to the database 120.

In order to replicate the data provided by the various data sources, the contractor 102 may run automatic scheduled “jobs” (usually performed by software programs or programmed middleware or hardware components) on the database 120 via the database server 112. These jobs provide error logs and automatic notifications to the contractor 102 upon the failure of some aspect of the system. Such jobs are automatically executed every three minutes or less, or as close to real-time as possible given the rate information is received by the contractor or input to the database 120. For example, a “flight data update” job may serve to take in the positioning information provided by the software described above and update appropriate modules in the database 120 in accordance with a flight's status. As noted above, flight statuses include “active”, “proposed”, “landed”, “one-way” or “transient”. These are statuses are based on the recorded (or filed) flight plans of the aircraft as well information obtained through the RLM and ACG software. Each status may be archived to a separate module in the database 120 for future analysis of an aircraft's flight history.

Similarly, an “availability” job is designed to record the one-way and transient availability of aircraft associated with the system, and a “demand” job is designed to record all information about each aircraft, airport, and aircraft service provider 101. By receiving information in the manner described above, and recording and updating information in the database 120 in accordance with jobs similar to those described above, it is possible to know the status, origin, destination, speed and capacity of all aircraft associated with the system and to use this information to minimize the occurrence of passenger-less flights and provide cost efficient and flexible private air travel service.

The database 120 is a highly normalized relational database that houses many different kinds of information and allows correlation of all the entities or objects that correspond to different aspects of the system. For example, objects or entities representing aircraft service providers are correlated with objects or entities representing aircraft that the aircraft service providers operate and/or own. Further, the system manipulates data imported to the system and provides normalized views of all the imported data. The contractor 102 may also “de-normalized” the different types of information into separate modules in the database 120. Such de-normalizing results in the fastest response time for the users of the system because the separate modules allow a user (usually a contractor or contractor personnel) to simply select information contained in one module via a display device, such as a computer monitor and a keyboard or mouse.

By manipulating the modules in the database, the system is able to provide conflict resolution for aircraft and aircraft service providers. For example, if an aircraft has been given a specific tail number and information concerning that tail number has been received by the system, the information will be stored in a conflict module which may be accessed by the database 120. Similarly, if a aircraft service provider 101 has a name, information received by the system concerning that name may likewise be stored in a conflict module in the database 120. The information stored in the conflict module may be compared to scheduled or proposed customer requests in order to assess the possibility of employing a particular aircraft or travel service provider to perform a particular service request. Modules may include objects or structures (sometimes referred to herein as “tables” or “entities”) in accordance with programming languages such as C, C++, JAVA, CORBA HTML, or the like. The information stored in the conflict module may then be used to update the system or the information may be discarded.

Further, in accordance with the database architecture, software and processes that enable automatic data feeds to the system can accommodate different data fields coming from separate data sources for the same kind of information. As noted above, the database architecture includes a conflict resolution system that identifies conflicting pieces of data coming from separate data sources. Additionally, an abstraction layer may be provided which will allow the introduction of new data sources at any time.

In accordance with an embodiment of the invention, tables are used in a client server application to present easy-to-use, fast, intuitive screens to the users of the system. The system may use the Microsoft® SQL Server™ 2000 however, the use of case tools and generic Entity Relationship (ER) Modeling helps ensure the portability of the database 120. Examples of entities (or tables) used in the system in accordance with Entity Relationship Modeling include, but are not limited to:

Entity ACTION_TYPE

Card of the entity ACTION_TYPE

| Name | ACTION_TYPE |
|---|---|
| Comment | An ACTION_TYPE table contains the action type name. The |
| | action type table may have many customer histories |
| | associated with it. The data input to this table generally |
| | comes from contractor personnel. |

Entity ADDITION_TYPE

Card of the entity ADDITION_TYPE

| Name | ADDITION_TYPE |
|---|---|
| Comment | An ADDITION_TYPE table is used to |
| | indicate what type of addition is made |
| | against a customer travel card. |
| | Typical values for an |
| | ADDITION_TYPE are credit memo, |
| | endorsement, initial deposit, and |
| | additional deposit. |

Entity ADDRESS

Card of the entity ADDRESS

| Name | ADDRESS |
|---|---|
| Comment | An ADDRESS table contains data on addresses for service |
| | carriers and customers, such as a street address, a primary |
| | address indicator, etc. An ADDRESS may have many credit |
| | card numbers, a service carrier, a city, and a customer |
| | associated with it. An ADDRESS may have been last |
| | updated by one data source. The data input to this table |
| | generally comes from the ACG software and contractor |
| | personnel. |

Entity ADDRESS_TYPE

Card of the entity ADDRESS_TYPE

| Name | ADDRESS_TYPE |
|---|---|
| Comment | An ADDRESS_TYPE table contains |
| | possible address types in the system |
| | so that each ADDRESS entry can be |
| | associated with a certain |
| | ADDRESS_TYPE. Possible values are |
| | home, office, vacation home, FedEx, |
| | or old. This table allows the |
| | contractor to get in touch with its |
| | customers based on the |
| | ADDRESS_TYPE that designates a |
| | customer's whereabouts. |

Entity AIRCRAFT

Card of the entity AIRCRAFT

| Name | AIRCRAFT |
|---|---|
| Comment | An AIRCRAFT table contains data on all aircraft world- |
| | wide, including tail number, condition, rate, ARGUS rating, |
| | etc. An AIRCRAFT may have many photos associated with |
| | it, may have many flight legs, many transient periods, many |
| | one-way flights, and many features associated with it. An |
| | AIRCRAFT may be black listed many times, preferred many |
| | times, have many ARGUS audits, and fly for many fractional |
| | companies. An AIRCRAFT may have only one base airport, |
| | one service carrier, and one aircraft type associated with it. |
| | An AIRCRAFT may have been last updated by one data |
| | source. The data input to this table generally comes from the |
| | ACG software and contractor personnel. |

Entity AIRCRAFT_CATEGORY

Card of the entity AIRCRAFT_CATEGORY

| Name | AIRCRAFT_CATEGORY |
|---|---|
| Comment | An AIRCRAFT_CATEGORY table contains data on |
| | categories of planes including light jet, midsize jet, one way |
| | rate, round-trip rate, etc. An AIRCRAFT_CATEGORY may |
| | have many aircraft types and many flights associated with it. |
| | The data input to this table generally comes from contractor |
| | personnel. |

Entity AIRCRAFT FEATURE

Card of the entity AIRCRAFT_FEATURE

| Name | AIRCRAFT_FEATURE |
|---|---|
| Comment | An AIRCRAFT FEATURE table is a “join” table between the |
| | AIRCRAFT table and the AIRCRAFT_FEATURE_TYPE |
| | table. An aircraft may have many feature types and |
| | each feature type can belong to many aircraft. This |
| | necessitates a “many to many” relationship between |
| | the AIRCRAFT and the AIRCRAFT_FEATURE_TYPE |
| | tables and this relationship results in this |
| | AIRCRAFT_FEATURE table. A typical |
| | example of a feature would be TV, restroom, leather seats, |
| | etc. |

Entity AIRCRAFT_FEATURE_TYPE

Card of the entity AIRCRAFT_FEATURE_TYPE

| Name | AIRCRAFT_FEATURE_TYPE |
|---|---|
| Comment | An AIRCRAFT_FEATURE_TYPE contains the aircraft |
| | feature name. An AIRCRAFT_FEATURE_TYPE may have |
| | many aircraft associated with it. The data input to this table |
| | generally comes from contractor personnel. |

Entity AIRCRAFT_FILTER

Card of the entity AIRCRAFT_FILTER

| Name | AIRCRAFT_FILTER |
|---|---|
| Comment | An AIRCRAFT_FILTER table is a list of tail numbers |
| | corresponding to aircraft that were omitted from the |
| | active/proposed/landed flight tracking system. Each entry |
| | in this table may be a Structured Query Language (“SQL”) |
| | “like” expression that may be matched against any new real- |
| | time flight information received by the system. |

Entity AIRCRAFT_HISTORY

Card of entity AIRCRAFT_HISTORY

| Name | AIRCRAFT_HISTORY |
|---|---|
| Comment | An AIRCRAFT_HISTORY table is |
| | used to track customer and contractor |
| | feedback about an aircraft. The data |
| | input to this table generally comes |
| | from contractor personnel. |

Entity AIRCRAFT_PHOTO

Card of the entity AIRCRAFT_PHOTO

| Name | AIRCRAFT_PHOTO |
|---|---|
| Comment | An AIRCRAFT may have many AIRCRAFT_PHOTOs |
| | associated with it. The photos for an aircraft are kept in |
| | the AIRCRAFT_PHOTO table as a Binary Large Object |
| | (“BLOB”). |
| | Their order (most important to less important) is governed |
| | by an AIRPHO_ORDER flag. |

Entity AIRCRAFT_SAVED_SEARCH

Card of the entity AIRCRAFT_SAVED_SEARCH

| Name | AIRCRAFT_SAVED_SEARCH |
|---|---|
| Comment | This is an envelope table for a saved search. It may have a |
| | “one-to-many” relationship with the |
| | AIRCRAFT_SAVED_SEARCH_DETAIL table, where the |
| | parameters for the search are stored. A search name and |
| | search time frame that applies to all detail parameters may be |
| | saved in this table. A MAP_LAYER may point to a saved |
| | search to indicate that the particular layer will contain the |
| | results of a newly executed “saved search”. |

Entity AIRCRAFT_SAVED_SEARCH_DETAIL

Card of the entity AIRCRAFT_SAVED_SEARCH_DETAIL

| Name | AIRCRAFT_SAVED_SEARCH_DETAIL |
|---|---|
| Comment | AIRCRAFT_SAVED_SEARCH_DETAIL is a table for |
| | each parameter of a saved search. Each parameter contains |
| | information necessary in order to save the details for an |
| | active/proposed/landed/one-way or transient flight search. |
| | Parameters for all the statuses are the same and may include: |
| | current position, home base, departure position, destination |
| | position, ARGUS rating, plane type, features, etc. |

Entity AIRCRAFT_SUB_CATEGORY

Card of the entity AIRCRAFT_SUB_CATEGORY

| Name | AIRCRAFT_SUB_CATEGORY |
|---|---|
| Comment | This table is necessary to further categorize light, medium, |
| | heavy jets into light slow/light fast, medium slow/medium |
| | fast, etc. It is a detailed sub-table of the |
| | AIRCRAFT_CATEGORY table. |

Entity AIRCRAFT_SUB_CATEGORY_SPEED

Card of the entity AIRCRAFT_SUB_CATEGORY_SPEED

| Name | AIRCRAFT_SUB_CATEGORY_SPEED |
|---|---|
| Comment | For each entry in the AIRCRAFT_SUB_CATEGORY table |
| | there may be an associated speed of aircraft for a given hour |
| | of a flight. In the first hour, planes are generally slower, in |
| | the second hour, a little faster and then speed remains |
| | substantially constant until descent. So each sub category |
| | can have a list of hours for which there is a speed recorded. |
| | This table is a detailed sub-table of the |
| | AIRCRAFT_SUB_CATEGORY. |

Entity AIRCRAFT_TYPE

Card of the entity AIRCRAFT_TYPE

| Name | AIRCRAFT_TYPE |
|---|---|
| Comment | An AIRCRAFT_TYPE table contains an aircraft type name, |
| | the aircraft model name and the aircraft manufacturer's |
| | name. An AIRCRAFT_TYPE may have many aircraft and |
| | one aircraft category associated with it. An |
| | AIRCRAFT_TYPE may have been last updated by one data |
| | source. |

Entity AIRCRAFT_WATCH_LIST

Card of the entity AIRCRAFT_WATCH_LIST

| Name | AIRCRAFT_WATCH_LIST |
|---|---|
| Comment | An AIRCRAFT_WATCH_LIST table includes a static list of |
| | aircraft tail numbers. The table allows contractor personnel |
| | to group certain aircraft together for constant monitoring |
| | and/or tracking. Each AIRCRAFT_SAVED_SEARCH entity |
| | may be associated with an AIRCRAFT_WATCH_LIST in |
| | order to indicate the last search result. In this manner, if the |
| | search is marked as a real-time search (which means it will |
| | periodically be re-executed) the new result may be compared |
| | to an old result such that contractor personnel will be |
| | notified only of the new aircraft which may then be added to |
| | the associated AIRCRAFT_WATCH_LIST. A static fleet of |
| | aircraft, such as a competitor's aircraft or a partner carrier's |
| | aircraft may be easily monitored with this functionality. |

Entity AIRCRAFT_WATCH_LIST_DETAIL

Card of the entity AIRCRAFT_WATCH_LIST_DETAIL

| Name | AIRCRAFT_WATCH_LIST_DETAIL |
|---|---|
| Comment | An AIRCRAFT_WATCH_LIST_DETAIL table is used to |
| | save the actual aircraft identifications (AIRCRAFT_ID) of |
| | the “watched” tail numbers. An AIRCRAFT_WATCH_LIST |
| | entry has many AIRCRAFT_WATCH_LIST_DETAILs. In |
| | this way, the AIRCRAFT_WATCH_LIST contains an |
| | “envelope” of information for the watch list, and the |
| | AIRCRAFT_WATCH_LIST_DETAIL table contains all of |
| | the watched aircraft. |

Entity AIRPORT

Card of the entity AIRPORT

| Name | AIRPORT |
|---|---|
| Comment | An AIRPORT table contains data on all airports world-wide; |
| | Such as, airport code, address, runway length, etc. An |
| | AIRPORT may be the base for many aircraft and may have |
| | many transient planes and many airport services associated |
| | with it. An AIRPORT may have in one city and one time |
| | zone associated with it. An AIRPORT may have been last |
| | updated by one data source. The data input to this table |
| | generally comes from the ACG software and contractor |
| | personnel. |

Entity AIRPORT_SERVICE

Card of the entity AIRPORT_SERVICE

| Name | AIRPORT_SERVICE |
|---|---|
| Comment | An AIRPORT_SERVICE table contains the airport service |
| | name and notes. An AIRPOR_SERVICE may have many |
| | airports and one airport service type associated with it. The |
| | data input to this table generally comes from the ACG |
| | software and contractor personnel. |

Entity AIRPORT_SERVICE_JOIN

Card of the entity AIRPORT_SERVICE_JOIN

| Name | AIRPORT_SERVICE_JOIN |
|---|---|
| Comment | An AIRPORT_SERVICE_JOIN table is an internal table that |
| | allows a “many to many” relationship between airports and |
| | airport services. It contains primary keys from the airport |
| | table and the airport services table. An |
| | AIRPORT_SERVICE_JOIN table may have many telephone |
| | numbers, an airport and an airport service associated with it. |
| | The data to this table generally comes from the ACG |
| | software and contractor personnel. |

Entity AIRPORT_SERVICE_TYPE

Card of the entity AIRPORT_SERVICE_TYPE

| Name | AIRPORT_SERVICE_TYPE |
|---|---|
| Comment | An AIRPORT_SERVICE_TYPE table contains the airport |
| | service type name such as fixed base operations (“FBO”), |
| | limo service, etc. An AIRPORT_SERVICE_TYPE may have |
| | many airport services associated with it. The data input to this |
| | table generally comes from contractor personnel. |

Entity ARGUS_AUDIT

Card of the entity ARGUS_AUDIT

| Name | ARGUS_AUDIT |
|---|---|
| Comment | An ARGUS_AUDIT table contains audit data for a service |
| | carrier, such as part 135 certificate number and a date of an |
| | audit. An ARGUS_AUDIT table may have many types of |
| | argus audit data and only one service carrier associated with |
| | it. The data input to this table generally comes from the |
| | ARGUS software. |

Entity ARGUS_AUDIT_DATA

Card of the entity ARGUS_AUDIT_DATA

| Name | ARGUS_AUDIT_DATA |
|---|---|
| Comment | An ARGUS_AUDIT_DATA table contains audit data for an |
| | aircraft including and aircraft tail number, serial number, |
| | total time on the aircraft's engines, etc. The data input to this |
| | table generally comes from the ARGUS software. |

Entity ARGUS_RATING_NAME

Card of the entity ARGUS_RATING_NAME

| Name | ARGUS_RATING_NAME |
|---|---|
| Comment | An ARGUS_RATING_NAME table |
| | contains reference names for Argus |
| | ratings (e.g., silver, platinum, etc.). |

Entity BLACK_LIST_HISTORY

Card of the entity BLACK_LIST_HISTORY

| Name | BLACK_LIST_HISTORY |
|---|---|
| Comment | An aircraft or service carrier can be blacklisted. Instead of |
| | having a field in the CARRIER or AIRCRAFT tables, a |
| | separate table is provided to keep a history of all |
| | “blacklisting” events. |

Entity BLACK_LIST_REASON_TYPE

Card of the entity BLACK_LIST_REASON_TYPE

| Name | BLACK_LIST_REASON_TYPE |
|---|---|
| Comment | A BLACK_LIST_REASON_TYPE table contains the |
| | reason type name. It may have many black list histories |
| | associated with it. The data input to this table generally comes |
| | from contractor personnel. |

Entity CALENDAR_EVENT

Card of the entity CALENDAR_EVENT

| Name | CALENDAR_EVENT |
|---|---|
| Comment | A CALENDAR_EVENT table contains |
| | a date and an explanation of each |
| | event on contractor or contractor |
| | personnel calendar. |

Entity CARD_BALANCE

Card of the entity CARD_BALANCE

| Name | CARD_BALANCE |
|---|---|
| Comment | A CARD_BALANCE table holds the |
| | last know money balance for a travel |
| | card in accordance with a particular |
| | date. Data is input to this table |
| | automatically, via an accounting |
| | application. |

Entity CARRIER

Card of the entity CARRIER

| Name | CARRIER |
|---|---|
| Comment | A CARRIER table contains data on all service carriers (or |
| | other aircraft service providers) world-wide including name, |
| | web site, insurance certificate, ARGUS rating, etc. A |
| | CARRIER may have many addresses associated with it, |
| | many aircraft, many contacts, many notes, many e-mail |
| | addresses, many telephones, many flight legs, and many |
| | ARGUS audits associated with it. A CARRIER may be black |
| | listed many times, or may be a preferred service carrier many |
| | times. A CARRIER may fly one type of plane and may have |
| | one corresponding entry in a public operator. A CARRIER |
| | may have been last updated by one data source. The data |
| | input to this table generally comes from the ACG software |
| | and contractor personnel. |

Entity CARRIER_CONTACT

Card of the entity CARRIER_CONTACT

| Name | CARRIER_CONTACT |
|---|---|
| Comment | A CARRIER_CONTACT table contains data on an service |
| | carrier's contact name and position. A |
| | CARRIER_CONTACT may have many e-mail addresses and |
| | many telephone numbers associated with it. A |
| | CARRIER_CONTACT may be a contact for one service |
| | carrier and may have been last updated by one data source. |
| | The data input to this table generally comes from the ACG |
| | software and contractor personnel. |

Entity CARRIER_NOTE

Card of the entity CARRIER_NOTE

| Name | CARRIER_NOTE |
|---|---|
| Comment | A CARRIER_NOTE table contains notes for a service |
| | carrier. A CARRIER_NOTE may have one service carrier |
| | associated with it. The data input to this table generally |
| | comes from contractor personnel. |

Entity CATERING_PREFERENCE

Card of the entity CATERING_PREFERENCE

| Name | CATERING_PREFERENCE |
|---|---|
| Comment | A CATERING_PREFERENCE table |
| | holds catering preferences for |
| | customers. Data is input to this table |
| | by contractor personnel. |

Entity CERTIFICATE_HOLDER

Card of the entity CERTIFICATE_HOLDER

| Name | CERTIFICATE _HOLDER |
|---|---|
| Comment | A CERTIFICATE_HOLDER table |
| | receives important information from |
| | an auditing partner, such as ARGUS. |
| | The table represents all of the carriers |
| | that ARGUS has audited on behalf of |
| | the contractor. This table also shares a |
| | relationship with the AIRCRAFT table |
| | in order to indicate which AIRCRAFT |
| | ARGUS believes a particular carrier |
| | operates. |

Entity CITY

Card of the entity CITY

| Name | CITY |
|---|---|
| Comment | A CITY table contains a city name. A CITY may have many |
| | addresses, many airports and one state associated with it. |
| | The data input to this table generally comes from the ACG |
| | software and contractor personnel. |

Entity COMPETITIVE_SAVINGS

Card of the entity COMPETITIVE_SAVINGS

| Name | COMPETITIVE_SAVINGS |
|---|---|
| Comment | A COMPETITIVE_SAVINGS table is |
| | used to track the amount of money a |
| | customer and/or travel card has |
| | saved against the competition up to a |
| | given date. |

Entity CONTACT_TYPE

Card of the entity CONTACT_TYPE

| Name | CONTACT_TYPE |
|---|---|
| Comment | A CONTACT_TYPE table is a |
| | reference table that includes a list of |
| | each type of contact (e.g., spouse, |
| | child, president, etc.). It shares an |
| | entity relationship with the CARRIER |
| | and CUSTOMER tables. |

Entity COUNTRY

Card of the entity COUNTRY

| Name | COUNTRY |
|---|---|
| Comment | A COUNTRY table contains the country name and |
| | abbreviation. A COUNTRY may have many states |
| | associated with it. The data input to this table generally |
| | comes from the ACG software and contractor personnel. |

Entity CREDIT_CARD

Card of the entity CREDIT_CARD

| Name | CREDIT_CARD |
|---|---|
| Comment | A CREDIT_CARD table contains the credit card number and |
| | expiration date of a credit card. A CREDIT_CARD may have |
| | many flights associated with it. A CREDIT_CARD may |
| | have an address, a credit card type, and a customer |
| | associated with it and may have been last updated by one |
| | data source. The data input to this table generally comes |
| | from contractor personnel. |

Entity CREDIT_CARD_TYPE

Card of the entity CREDIT_CARD_TYPE

| Name | CREDIT_CARD_TYPE |
|---|---|
| Comment | A CREDIT_CARD_TYPE table contains the name (Visa, |
| | Mastercard, etc.) of a credit card. A CREDIT_CARD_TYPE |
| | may have many credit cards associated with it. The data |
| | input to this table generally comes from contractor |
| | personnel. |

Entity CUSTOMER

Card of the entity CUSTOMER

| Name | CUSTOMER |
|---|---|
| Comment | A CUSTOMER table contains data on all customers world- |
| | wide including name, company, if any, business title, if any, |
| | etc. A CUSTOMER have many addresses, many credit cards, |
| | many contacts, many notes, and many e-mail addresses |
| | associated with it. A CUSTOMER may also have many |
| | flights, many telephone numbers, many travel cards, and |
| | many cases associated with it. A CUSTOMER may have a |
| | reference and a type associated with it and may have been |
| | last updated by one data source. The data input to this table |
| | generally comes from contractor personnel. |

Entity CUSTOMER_ACTION_HISTORY

Card of the entity CUSTOMER_ACTION_HISTORY

| Name | CUSTOMER_ACTION_HISTORY |
|---|---|
| Comment | A CUSTOMER_ACTION_HISTORY table contains history |
| | information about customer actions; such as the date a |
| | customer account was created, a date service for the |
| | customer was initiated or is due, the date service is |
| | completed, who a service request has been assigned to, etc. |
| | A CUSTOMER_ACTION_HISTORY table may have a |
| | customer case, an action type and a user (a contractor or |
| | contractor personnel) associated with it. The data input to |
| | this table generally comes from contractor personnel. |

Entity CUSTOMER_CASE

Card of the entity CUSTOMER_CASE

| Name | CUSTOMER_CASE |
|---|---|
| Comment | The CUSTOMER_CASE table contains a customer case |
| | name and customer case creation date. A CUSTOMER_{—} |
| | CASE may have many customer action histories associated |
| | with it, one customer and one user associated with it. |
| | The data input to this table generally comes from |
| | contractor personnel. |

Entity CUSTOMER_CONTACT

Card of the entity CUSTOMER_CONTACT

| Name | CUSTOMER_CONTACT |
|---|---|
| Comment | A CUSTOMER_CONTACT table contains data on the |
| | contact's name and title. A CUSTOMER_CONTACT may |
| | have many e-mail addresses and many telephone numbers |
| | associated with it. A CUSTOMER_CONTACT may have one |
| | customer associated with it and may have been last updated |
| | by one data source. The data input to this table generally |
| | comes from contractor personnel. |

Entity CUSTOMER_FEEDBACK

Card of the entity CUSTOMER_FEEDBACK

| Name | CUSTOMER_FEEDBACK |
|---|---|
| Comment | A CUSTOMER_FEEDBACK table |
| | contains feedback from a particular |
| | customer with respect to a flight. |

Entity CUSTOMER_FEEDBACK TOPIC

Card of the entity CUSTOMER_FEEDBACK TOPIC

| Name | CUSTOMER_FEEDBACK_TOPIC |
|---|---|
| Comment | A CUSTOMER_FEEDBACK_TOPIC |
| | table is a reference table that contains |
| | topics from customer feedback |
| | postcards (e.g., quality of catering, |
| | aircraft condition, etc.). |

Entity CUSTOMER_FEEDBACK TOPIC_JOIN

Card of entity CUSTOMER_FEEDBACK_TOPIC_JOIN

| Name | CUSTOMER_FEEDBACK_TOPIC_JOIN |
|---|---|
| Comment | A CUSTOMER_FEEDBACK_TOPIC_JOIN |
| | table is a table that allows a |
| | many-to-many entity relationship |
| | between CUSTOMER_FEEDBACK |
| | and CUSTOMER_FEEDBACK_TOPIC |
| | tables. |

Entity CUSTOMER_NOTE

Card of the entity CUSTOMER_NOTE

| Name | CUSTOMER_NOTE |
|---|---|
| Comment | A CUSTOMER_NOTE table contains a note. A |
| | CUSTOMER_NOTE may have one customer and a user that |
| | created the note associated with it. A CUSTOMER_NOTE |
| | may have been last updated by one data source. The data |
| | input to this table generally comes from contractor |
| | personnel. |

Entity CUSTOMER_TYPE

Card of the entity CUSTOMER_TYPE

| Name | CUSTOMER_TYPE |
|---|---|
| Comment | A CUSTOMER_TYPE table contains the customer type |
| | name. A CUSTOMER_TYPE may have many customers |
| | associated with it. The data input to this table generally |
| | comes from contractor personnel. |

Entity DATA_SOURCE

Card of the entity DATA_SOURCE

| Name | DATA_SOURCE |
|---|---|
| Comment | A DATA_SOURCE table contains a data source name. It is a |
| | mechanism used in many tables to show which data source |
| | last updated the information in the table. A DATA_SOURCE |
| | may have many aircraft, many service carriers, many |
| | airports, many service carrier contacts, many e-mails, many |
| | addresses, many telephones, many customers, many |
| | customer notes, many customer contacts, many credit cards, |
| | many one way aircraft, many transient aircraft and many |
| | aircraft types associated with it. The data input to this table |
| | generally comes from contractor personnel. |

Entity DEDUCTION_TYPE

Card of the entity DEDUCTION_TYPE

| Name | DEDUCTION_TYPE |
|---|---|
| Comment | A DEDUCTION_TYPE table holds |
| | values for different types of |
| | deductions that can be applied to the |
| | balance associated with a customer or |
| | travel card. Data input to this table |
| | comes from contractor personnel. |

Entity EMAIL

Card of the entity EMAIL

| Name | EMAIL |
|---|---|
| Comment | A EMAIL table contains the email address and a primary |
| | email address indicator. An EMAIL may have one customer, |
| | one service carrier, one service carrier contact, or one |
| | customer contact associated with it. An EMAIL may have |
| | been last updated by one data source. The data input to this |
| | table generally comes from the ACG software and contractor |
| | personnel. |

Entity EVENT_TYPE

Card of the entity EVENT_TYPE

| Name | EVENT_TYPE |
|---|---|
| Comment | An EVENT_TYPE table holds |
| | customer and contractor feedback |
| | types to be used in relation with an |
| | AIRCRAFT_HISTORY table. |

Entity FLIGHT

Card of the entity FLIGHT

| Name | FLIGHT |
|---|---|
| Comment | A FLIGHT table contains information about a flight |
| | including the start and end times, a round-trip indicator, a |
| | number of passengers, etc. A FLIGHT may have many flight |
| | legs and many travel card histories associated with it. A |
| | FLIGHT may also have a customer, a user, a flight state, a |
| | travel card, a credit card and an aircraft category associated |
| | with it. The data input to this table generally comes from |
| | contractor personnel. |

Entity FLIGHTLEG_ALTERNATE

Card of the entity FLIGHTLEG_ALTERNATE

| Name | FLIGHTLEG_ALTERNATE |
|---|---|
| Comment | A FLIGHTLEG_ALTERNATE table is |
| | associated with one or more a |
| | FLIGHT_LEG tables. Each |
| | FLIGHT_LEG may have many |
| | FLIGHTLEG_ALTERNATEs. If there |
| | is a cancellation or mechanical |
| | problem associated with a |
| | FLIGHT_LEG, a contractor already |
| | has a record of multiple equally suited |
| | aircraft which may be used as an |
| | alternative. |

Entity FLIGHT_DATA Card of the entity FLIGHT_DATA

| Name | FLIGHT_DATA |
|---|---|
| Comment | A FLIGHT_DATA table contains data on all flights tracked |
| | by the FAA (a filed or recorded flight plan). It contains |
| | information such as a tail number, flight status, origin and |
| | destination airports, start and end times and current |
| | positional information such as longitude, latitude, altitude, |
| | heading and speed. This information is received by satellite |
| | every 3 minutes or less and is processed into the system's |
| | normalized database. The data input to this table come from |
| | the RLM software. |

Entity FLIGHT_LANDING

Card of the entity FLIGHT_LANDING

| Name | FLIGHT_LANDING |
|---|---|
| Comment | A FLIGHT_LANDING table is populated by system software |
| | that processes flights from the FLIGHT_DATA table with a |
| | flight status of “L”. It contains information such as tail |
| | number, origin and destination airport, start and end times |
| | and a date and time of the landing (in ZULU format). |

Entity FLIGHT_LEG

Card of the entity FLIGHT_LEG

| Name | FLIGHT_LEG |
|---|---|
| Comment | A FLIGHT_LEG table contains data such as origin and |
| | destination airport, start and end times, service carrier |
| | quote, etc. A FLIGHT_LEG may have many grouped flights, |
| | many one ways flights, many aircraft watch lists, and many |
| | aircraft saved searches associated with it. A FLIGHT_LEG |
| | may have one aircraft, one service carrier, one flight and one |
| | upgrade type associated with it. The data input to this table |
| | generally comes from contractor personnel. |

Entity FLIGHT_STATE

Card of the entity FLIGHT_STATE

| Name | FLIGHT_STATE |
|---|---|
| Comment | A FLIGHT_STATE table contains the flight state name. The |
| | flight state may have many flights associated with it. The |
| | data input to this table generally comes from contractor |
| | personnel. |

Entity FRACTIONAL_AIRCRAFT_JOIN

Card of the entity FRACTIONAL_AIRCRAFT_JOIN

| Name | FRACTIONAL_AIRCRAFT_JOIN |
|---|---|
| Comment | A FRACTION_AIRCRAFT_JOIN table is an internal table |
| | that allows a “many to many” relationship between fractional |
| | aircraft and fractional companies. It links an aircraft with a |
| | fractional company, so ultimately one aircraft can be linked |
| | to many companies and one company can be linked to many |
| | aircraft. |

Entity FRACTIONAL_COMPANIES

Card of the entity FRACTIONAL_COMPANIES

| Name | FRACTIONAL_COMPANIES |
|---|---|
| Comment | A FRACTIONAL_COMPANIES table contains the name of |
| | a fractional company. It may have many fractional aircraft |
| | associated with it. The data input to this table generally |
| | comes from contractor personnel. |

Entity FRACTIONAL_OWNERS

Card of the entity FRACTIONAL_OWNERS

| Name | FRACTIONAL_OWNERS |
|---|---|
| Comment | A FRACTIONAL_OWNERS table includes a list of a |
| | contractor's fractional ownership competitors. Each aircraft |
| | in the contractor's inventory may be tracked as to whether it |
| | is also used by these fractional ownership companies. The |
| | contractor may then conduct a competitive analysis with |
| | respect to particular situations. |

Entity GLOBAL_PARAMETERS

Card of the entity GLOBAL_PARAMETERS

| Name | GLOBAL_PARAMETERS |
|---|---|
| Comment | A GLOBAL_PARAMETERS table is used to store all of the |
| | contractor's persistent global parameters, such as strings, |
| | colors, labels, numbers, monetary values, taxes, and |
| | percentages. These values are not hard-coded into software |
| | and thus can be modified at run-time by just changing the |
| | appropriate database fields. The USER_PARAMETERS table |
| | shares a relationship to this table in that it “inherits” from this |
| | table. The software of the system has certain functions that |
| | look for a “per user” value of the user parameters and, if it |
| | cannot find any, the software functions will default to the |
| | global parameters. |

Entity GROUND_TRANSPORTATION

Card of the entity GROUND_TRANSPORTATION

| Name | GROUND_TRANSPORTATION |
|---|---|
| Comment | A GROUND_TRANSPORTATION |
| | table includes information related to |
| | the type of ground transportation that |
| | may be supplied for a flight leg (e.g., |
| | who is meeting the plane, this |
| | person's phone number, etc.). |

Entity GROUND_TRANSPORTATON_TYPE

Card of the entity GROUND_TRANSPORTATION_TYPE

| | |
|---|---|
| Name | GROUND_TRANSPORTATION_TYPE |
| Comment | A GROUND_TRANSPORTATION_TYPE |
| | table is a reference table that |
| | includes the types of ground |
| | transportation to be supplied for a |
| | flight leg (e.g., car service, taxi, private |
| | party, etc.). |

Entity GROUPED_FLIGHT

Card of the entity GROUPED_FLIGHT

| Name | GROUPED_FLIGHT |
|---|---|
| Comment | A GROUPED_FLIGHT table contains data such as the time a |
| | group flight is created and an overall cost of the group flight. |
| | A GROUPED_FLIGHT may have many flight legs |
| | associated with it. The data input to this table generally comes |
| | from contractor personnel. |

Entity GROUPED_FLIGHT^{—}JOIN

Card of the entity GROUPED_FLIGHT_JOIN

| Name | GROUPED_FLIGHT_JOIN |
|---|---|
| Comment | A GROUPED_FLIGHT_JOIN table is an internal table that |
| | allows a “many to many” relationship between grouped |
| | flights and flight legs. It contains primary keys from the |
| | GROUP_FLIGHT_TABLE and the FLIGHT_LEG table. |
| | The data input to this table generally comes from contractor |
| | personnel. |

Entity MAP_LAYER

A “layer” is a visualization of the MAP_LAYER entity. Persistent fields in the MAP_LAYER are used to determine the visual characteristics of the layer as well as the elements that are actually displayed via a user interface (for instance, via a user interface of a command center module.) A layer may be a weather overlay layer, a saved search layer (which constitutes search criteria to be executed in order determine which tail numbers are displayed), or a watch list layer (which constitutes a static list of tail numbers to be watched). Further, by employing layers, a given aircraft can be displayed to a user together with its base, departure, and destination airports as well as its route. Card of the entity MAP_LAYER

| Name | MAP_LAYER |
|---|---|
| Comment | A MAP_LAYER table includes all of the parameters |
| | necessary to keep track of a given map layer in the mapping |
| | screens of the contractor's command center application. |
| | These parameters include visibility, color, font, size, active, |
| | proposed, landed, transient, one-way flights and origins, |
| | destinations and base airports. This table also includes |
| | aspects of labeling. |

Entity MARKETING_EVENT

Card of the entity MARKETING_EVENT

| Name | MARKETING_EVENT |
|---|---|
| Comment | A MARKETING_EVENT table may be |
| | used to store all marketing events that |
| | a contractor has sent to customers, |
| | potential customers, and to the public |
| | generally. |

Entity MARKETING_EVENT_BATCH

Card of the entity MARKETING_EVENT_BATCH

| Name | MARKETING_EVENT_BATCH |
|---|---|
| Comment | A MARKETING_EVENT_BATCH |
| | table may be used to split customers, |
| | potential customers, and the public |
| | generally into batches for a marketing |
| | event. |

Entity MARKETING_EVENT_CUSTOMERS

Card for the entity MARKETING_EVENT_CUSTOMERS

| Name | MARKETING_EVENT_CUSTOMERS |
|---|---|
| Comment | A MARKETING_EVENT_CUSTOMERS |
| | table may be used to |
| | store names or identifications of |
| | customers that belong to a marketing |
| | event. |

Entity MARKETING_EVENT_MEDIUM

Card for the entity MARKETING_EVENT_MEDIUM

| Name | MARKETING_EVENT_MEDIUM |
|---|---|
| Comment | A MARKETING_EVENT_MEDIUM |
| | table may be used to store the types of |
| | material that should be distributed |
| | during a marketing event. |

Entity MARKETING_EVENT_TYPE

Card for the entity MARKETING_EVENT_TYPE

| Name | MARKETING_EVENT_TYPE |
|---|---|
| Comment | A MARKETING_EVENT_TYPE table |
| | may be used to store different types of |
| | marketing events and the SQL used to |
| | retrieve customers for a particular |
| | type. |

Entity ONE_WAY

Card of the entity ONE_WAY

| Name | ONE_WAY |
|---|---|
| Comment | A ONE_WAY table contains the start and end times of a one |
| | way flight, the origin and destination airports of the one way |
| | flight, a booked indicator, etc. A ONE_WAY is one aircraft |
| | on one flight leg and may have been last updated by one data |
| | source. The data input to this table generally comes from the |
| | ACG software and contractor personnel. |

Entity OWNER

Card of the entity OWNER

| Name | OWNER |
|---|---|
| Comment | An OWNER table may be employed as an intermediate |
| | import table which specifies all of the aspects of an owner of |
| | an aircraft. |

Entity PASSENGER

Card of the entity PASSENGER

| Name | PASSENGER |
|---|---|
| Comment | A PASSENGER table may be used to |
| | store the names or identifications of |
| | passengers that have been included in |
| | a flight for a customer. Data is input |
| | to this table by contractor personnel. |

Entity PASSENGER_MANIFEST

Card of the entity PASSENGER_MANIFEST

| Name | PASSENGER_MANIFEST |
|---|---|
| Comment | A PASSENGER_MANIFEST table |
| | may be used to store the names or |
| | identifications of all the passengers for |
| | each flight leg. A passenger may be |
| | an existing customer or a new name |
| | associated with a single flight leg. |
| | Data is input to this table |
| | automatically, via an application. |

Entity PLANE_TYPES

Card of the entity PLANE_TYPES

| Name | PLANE_TYPES |
|---|---|
| Comment | A PLANE_TYPES table contains the plane type name. A |
| | PLANE_TYPES may have many service carriers associated |
| | with it. The data input to this table generally comes from |
| | contractor personnel. |

Entity PREFERRED_LIST

Card of the entity PREFERRED_LIST

| Name | PREFERRED_LIST |
|---|---|
| Comment | Same as the BLACK_LIST table concept except that this is |
| | for indicating a “preferred” status. |

Entity PREFERRED_LIST_REASON_TYPE

Card of the entity PREFERRED_LIST_REASON_TYPE

| Name | PREFERRED_LIST_REASON_TYPE |
|---|---|
| Comment | A PREFERRED_LIST_REASON_TYPE table contains the |
| | reason type name. It may have many preferred lists |
| | associated with it. The data input to this table generally |
| | comes from contractor personnel. |

Entity PROSPECT_RATING

Card of the entity PROSPECT_RATING

| Name | PROSPECT_RATING |
|---|---|
| Comment | A PROSPECT_RATING table may be |
| | used to store values associated with |
| | prospective travel card customers. |

Entity PUBLIC_AIRCRAFT

Card of the entity PUBLIC_AIRCRAFT

| Name | PUBLIC_AIRCRAFT |
|---|---|
| Comment | A PUBLIC_AIRCRAFT table includes aircraft information. |
| | It is an intermediate import table that serves as destination of |
| | scheduled imports of information from external data sources. |
| | After the information is imported, the values of this table get |
| | imported into the AIRCRAFT table with the appropriate |
| | DATA_SOURCE flags set. |

Entity PUBLIC_AIRPORTS

Card of the entity PUBLIC_AIRPORTS

| Name | PUBLIC_AIRPORTS |
|---|---|
| Comment | A PUBLIC_AIRPORT table includes airport information. |
| | It is an intermediate import table that serves as destination of |
| | scheduled imports of information from external data sources. |
| | After the information is imported, the values of this table get |
| | imported into the AIRPORT table with the appropriate |
| | DATA_SOURCE flags set. |

Entity PUBLIC_AVAILABILITY

Card of the entity PUBLIC_AVAILABILITY

| Name | PUBLIC_AVAILABILITY |
|---|---|
| Comment | A PUBLIC_AVAILABILITY table includes availability |
| | information. It is an intermediate import table that serves as |
| | destination of scheduled imports of information from |
| | external data sources. After the information is imported, the |
| | values of this table get imported into the ONE_WAY and/or |
| | TRANSIENT tables with the appropriate DATA_SOURCE |
| | flags set. |

Entity PUBLIC_OPERATOR

Card of the entity PUBLIC_OPERATOR

| Name | PUBLIC_OPERATOR |
|---|---|
| Comment | A PUBLIC_OPERATOR table includes carrier information. |
| | It is an intermediate import table that serves as destination of |
| | scheduled imports of information from external data sources. |
| | After the information is imported, the values of this table get |
| | imported into the CARRIER table with the appropriate |
| | DATA_SOURCE flags set. Note that while some external |
| | sources use the terminology “OPERATOR”, contractors may |
| | use the term “CARRIERS” to describe the concept of the |
| | entity that operationally manages the aircraft. |

Entity PUBLIC_STDCRAFT

Card of the entity PUBLIC_STDCRAFT

| Name | PUBLIC_STDCRAFT |
|---|---|
| Comment | A PUBLIC_STDCRAFT table includes information |
| | associated with de-normalized aircraft type, aircraft |
| | category, aircraft manufacturer, etc. It is an intermediate |
| | import table that serves as destination of scheduled imports of |
| | information from external data sources. After the information |
| | is imported, the values of this table get imported into the |
| | AIRCRAFT_TYPE and/or AIRCRAFT_CATEGORY tables |
| | with the appropriate DATA SOURCE flags set. |

Entity REFFERRED_BY

Card of the entity REFERRED_BY

| Name | REFERRED_BY |
|---|---|
| Comment | A REFERRED_BY table contains a reference name (Wall St. |
| | Journal, etc.). A REFERRED_BY may have many customers |
| | associated with it. The data input to this table generally |
| | comes from contractor personnel. |

Entity REPORT

Card of the entity REPORT

| Name | REPORT |
|---|---|
| Comment | A REPORT table includes all reports |
| | that may be printed or accessed by |
| | contractor personnel. This allows |
| | contractor administrafion to change a |
| | report template in the database such |
| | that contractor personnel has |
| | immediate access to the new report. |
| | A report object is contained in a |
| | report_template field. Data is input to |
| | this table by contractor |
| | administration. |

Entity SECURITY_LEVEL

Card of the entity SECURITY_LEVEL

| Name | SECURITY_LEVEL |
|---|---|
| Comment | A SECURITY_LEVEL table contains a security level name. |
| | A SECURITY_LEVEL may have many users associated with |
| | it. The data input to this table generally comes from contractor |
| | personnel. |

Entity SHIPMENT_METHOD

Card of the entity SHIPMENT_METHOD

| Name | SHIPMENT_METHOD |
|---|---|
| Comment | A SHIPMENT_METHOD table is a |
| | reference table that describes various |
| | methods a contractor may use to ship |
| | things to customers (e.g., FedEx, UPS, |
| | etc.). |

Entity STANDARD_VERBAGE

Card of the entity STANDARD_VERBAGE

| Name | STANDARD_VERBAGE |
|---|---|
| Comment | A STANDARD_VERBAGE table may |
| | be used as a repository of verbiage |
| | used in reports and labels. |

Entity STATE

Card of the entity STATE

| Name | STATE |
|---|---|
| Comment | A STATE table contains the state name and abbreviation. A |
| | STATE may have many cities and one country associated |
| | with it. The data input to this table generally comes from the |
| | ACG software and contractor personnel. |

Entity TELEPHONE

Card of the entity TELEPHONE

| Name | TELEPHONE |
|---|---|
| Comment | A TELEPHONE table contains data on telephone numbers |
| | for service carrier contacts, service carriers, customer |
| | contacts, customers, and airport services including telephone |
| | number and a primary telephone number indicator. A |
| | TELEPHONE may have one service carrier contact, one |
| | service carrier, one customer contact, one customer, may one |
| | airport service, and one telephone type associated with it. A |
| | TELEPHONE may have been last updated by one data |
| | source. The data input to this table generally comes from the |
| | ACG software and contractor personnel. |

Entity TELEPHONE_TYPE

Card of the entity TELEPHONE_TYPE

| Name | TELEPHONE_TYPE |
|---|---|
| Comment | A TELEPHONE_TYPE table contains a telephone type |
| | name. A TELEPHONE_TYPE may have many telephones |
| | associated with it. The data input to this table generally |
| | comes from the ACG software and contractor personnel. |

Entity TIME_ZONE

Card of the entity TIME_ZONE

| Name | TIME_ZONE |
|---|---|
| Comment | A TIME_ZONE table contains a time zone name and its |
| | hours (according to ZULU). A TIME_ZONE may have |
| | many airports associated with it. The data input to this table |
| | generally comes from contractor personnel. |

Entity TRANSIENT

Card of the entity TRANSIENT

| Name | TRANSIENT |
|---|---|
| Comment | A TRANSIENT table contains the start and end times of a |
| | transient state, booked indicator, etc. A TRANSIENT plane |
| | may have one aircraft and one airport associated with it and |
| | may have been last updated by one data source. The data |
| | input to this table generally comes from the ACG software |
| | and contractor personnel. |

Entity TRAVEL_CARD

Card of the entity TRAVEL_CARD

| Name | TRAVEL_CARD |
|---|---|
| Comment | A TRAVEL_CARD table contains a travel card number. A |
| | TRAVEL_CARD may have many travel card customers, |
| | many travel card histories, and many flights associated with |
| | it. The data input to this table generally comes from |
| | contractor personnel. |

Entity TRAVEL_CARD_CUSTOMER_JOIN

Card of the entity TRAVEL_CARD_CUSTOMER_JOIN

| Name | TRAVEL_CARD_CUSTOMER_JOIN |
|---|---|
| Comment | A TRAVEL_CARD_CUSTOMER_JOIN table is an internal |
| | table that allows a “many to many” relationship between |
| | travel cards and customers. It contains primary keys from a |
| | TRAVEL_CARD table and a CUSTOMER table as well as a |
| | primary travel card indicator for a customer. The data input |
| | to this table generally comes from contractor personnel. |

Entity TRAVEL_CARD_HISTORY

Card of the entity TRAVEL_CARD_HISTORY

| Name | TRAVEL_CARD_HISTORY |
|---|---|
| Comment | A TRAVE_CARD_HISTORY table contains the date, |
| | amount and deposit indicator for a travel card. A |
| | TRAVEL_CARD_HISTORY may have one travel card |
| | and one flight associated with it. The data input to this table |
| | generally comes from contractor personnel. |

Entity TRAVEL_CARD_REFERRAL

Card of the entity TRAVEL_CARD_REFERRAL

| Name | TRAVEL_CARD_REFERRAL |
|---|---|
| Comment | A TRAVEL_CARD_REFERRAL table |
| | includes the name or identification of |
| | a customer who may refer other |
| | customers, such as a primary travel |
| | card holder or a customer on a travel |
| | card account |

Entity UPGRADE_BALANCE

Card of the entity UPGRADE BALANCE

| Name | UPGRADE_BALANCE |
|---|---|
| Comments | An UPGRADE_BALANCE table |
| | includes a last known upgrade |
| | balance amount associated with a |
| | customer or travel card for a given |
| | date. Data may be input to this table |
| | automatically via an accounting |
| | application. |

Entity UPGRADE_SAVINGS

Card of the entity UPGRADE_SAVINGS

| Name | UPGRADE_SAVINGS |
|---|---|
| Comment | An UPGRADE_SAVINGS table may |
| | be used to track how much money a |
| | customer or travel card has saved |
| | because of complimentary upgrades |
| | up to a given date. Data may be input |
| | to this table automatically, via an |
| | accounting application. |

Entity UPGRADE_TYPE

Card of the entity UPGRADE_TYPE

| Name | UPGRADE_TYPE |
|---|---|
| Comment | A UPGRADE_TYPE table contains an upgrade type name. |
| | An UPGRADE_TYPE may have many flight legs associated |
| | with it. The data input to this table generally comes from |
| | contractor personnel. |

Entity USERS

Card of the entity USERS

| Name | USERS |
|---|---|
| Comment | A USERS table contains a contractor personnel name, user- |
| | name, password and email address. A USER may have |
| | many customer notes, many flights, many customer cases, |
| | many customer actions, many aircraft watch lists, many |
| | aircraft saved searches, many user map configurations, |
| | many user parameters and one security level associated with |
| | it. The data input to this table generally comes from |
| | contractor personnel. |

Entity USER_MAP_CONFIGURATION

Card of the entity USER_MAP_CONFIGURATION

| Name | USER_MAP_CONFIGURATION |
|---|---|
| Comment | A USER_MAP_CONFIGURATION table is an |
| | encapsulation of two or more MAP_LAYER tables. |
| | In this manner, a user may choose layers A, B, and C as |
| | a named configuration and layers D, C, and E as a |
| | different one. |

Entity USER_PARAMETERS

Card of the entity USER_PARAMETERS

| Name | USER_PARAMETERS |
|---|---|
| Comment | A USER_PARAMETERS table is a table that may “inherit” |
| | from the GLOBAL_PARAMETERS table. Any value in the |
| | GLOBAL_PARAMETERS table can be over-written on a per |
| | user basis in the USER_PARAMETERS table. |

Entity WEATHER_LAYER

Card of the entity WEATHER_LAYER

| Name | WEATHER_LAYER |
|---|---|
| Comment | A WEATHER_LAYER table may be used to store weather |
| | maps and may be associated with a MAP_LAYER. Any layer |
| | that points to a WEATHER_LAYER is meant to exclusively |
| | render a weather map in that layer. |

Entity WIND_SPEED

Card of the entity WIND_SPEED

| Name | WIND_SPEED |
|---|---|
| Comment | A WIND_SPEED table may be used to perform flight |
| | calculations. In order to calculate the head and tail wind |
| | components of a flight, one needs to have wind speeds and |
| | directions at certain altitudes and coordinates. |

Enity ZIP_CODE

Card of the entity ZIP_CODE

| Name | ZIP_CODE |
|---|---|
| Comment | A ZIP_CODE table includes zip code |
| | information for all the zip codes in the |
| | United States. The table also includes |
| | related information such as city, state, |
| | county, area code, etc. |

Each of the entities above further includes one or more attributes. For example, an AIRPORT entity may have the following attributes:

AIRPORT

| AIRPOR ID | AUTO ID |
|---|---|
| AIRPOR_NAME | LONG_NAME |
| AIRPOR_NUMBER_OF_RUNWAYS | SMALL_NUMBER |
| AIRPOR_LR_LENGTH | SMALL_NUMBER |
| AIRPOR_LR_SURFACE | MEDIUM_NUMBER |
| AIRPOR_ELEVATION | SMALL_NUMBER |
| AIRPOR_PUBLIC | BOOLEAN |
| AIRPOR_LATITUDE | COORDINATE |
| AIRPOR_LONGITUDE | COORDINATE |
| AIRPOR_ABBREV | SHORT_NAME |
| AIRPOR_TOWER_NUMBER | MEDIUM_NAME |
| AIRPOR_FAA_CODE | SHORT_NAME |
| AIRPOR_ICAO_CODE | SHORT_NAME |
| AIRPOR_IATA_CODE | SHORT_NAME |
| AIRPOR_MAP | BMP |

Examples of other tools that may be used to develop the database 120 include but are not limited to: Borland® Delphi™ 5.0 Enterprise, Sybase® PowerDesignor 7.5, Microsoft® Project 2000, Microsoft® Visio 2000, Microsoft® Visual Sourcesafe™ 6.0 and Client Tools. By using these software and middleware tools, and the database 120, a flight command center application is created that enables the contractor 102 and contractor personnel (sometimes referred to herein as “users”) to keep track of customers, aircraft, and aircraft service providers; find aircraft and aircraft service providers by providing real-time search criteria; price and schedule flights for customers; keep track of customer flights and flight legs; integrate flight and customer information with an accounting system; keep track of airports and airport and other travel services; keep track of all active, proposed, and landed aircraft in real-time; keep track of all reported one-way and transient aircraft; keep track of status histories; and present reports on all areas of the contractor's business.

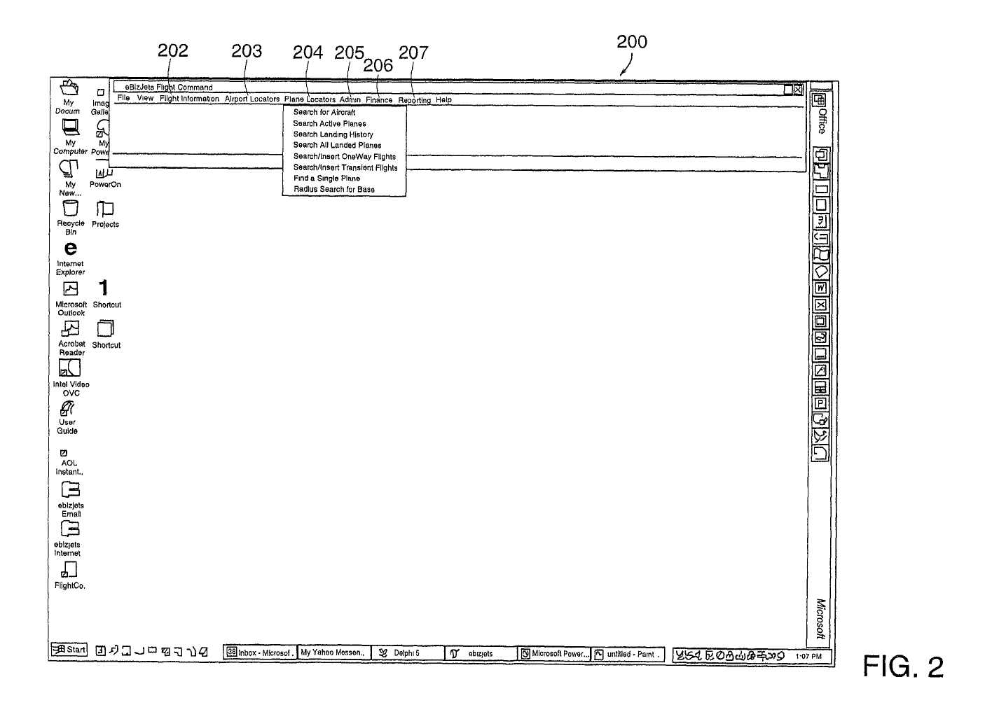

FIG. 2 is an illustration of a graphical user interface which may be used to provide private air travel in accordance with another embodiment of the invention. The graphical user interface 200 provides a contractor 102 (or other user) with a screen 201 that will allow the contractor to find and/or enter all information for a customer including one or more credit card numbers, addresses, phone numbers, email addresses, contacts (if the customer is a corporate entity) as well as information regarding the contacts, aircraft preferences, and all other preferences. Through the interface 200, the contractor may create actions that need to be taken on behalf of a customer, such as sending flight information or other travel information to or for the customer, or sending follow-up information on a particular flight. A contractor can create an action and assign it to someone else to complete, such as to contractor personnel or one or more travel service providers 109. All the users of the interface 200 (including contractor personnel and administrators) with proper security clearance can view an action task list and see tasks that are assigned to each user.

The graphical user interface 200 also includes an electronic link to a module which provides a flight entry interface (or screen) that allows a contractor or contractor personnel to create a new flight for a customer. Via the flight entry screen, the contractor may select which of the customer's credit cards to charge the flight to, calculate the cost of the flight, and schedule one or more flight legs. The contractor may also view all data related to flights the customer has scheduled with the contractor. Once a flight is created through the flight screen, it is automatically entered into a flight calender which may be displayed by a related interface. Similarly, the contractor may edit data related to a flight and save the changes to the system. The flight calender will automatically be updated in accordance with the changes. The interface includes pull down menus 202, 203, 204, 205, 206, and 207 that provide a user with electronic links to modules which provide a flight information interface, an airport locator interface, an aircraft locator interface, an administrative information interface, a finance information interface, and a reporting interface respectively.

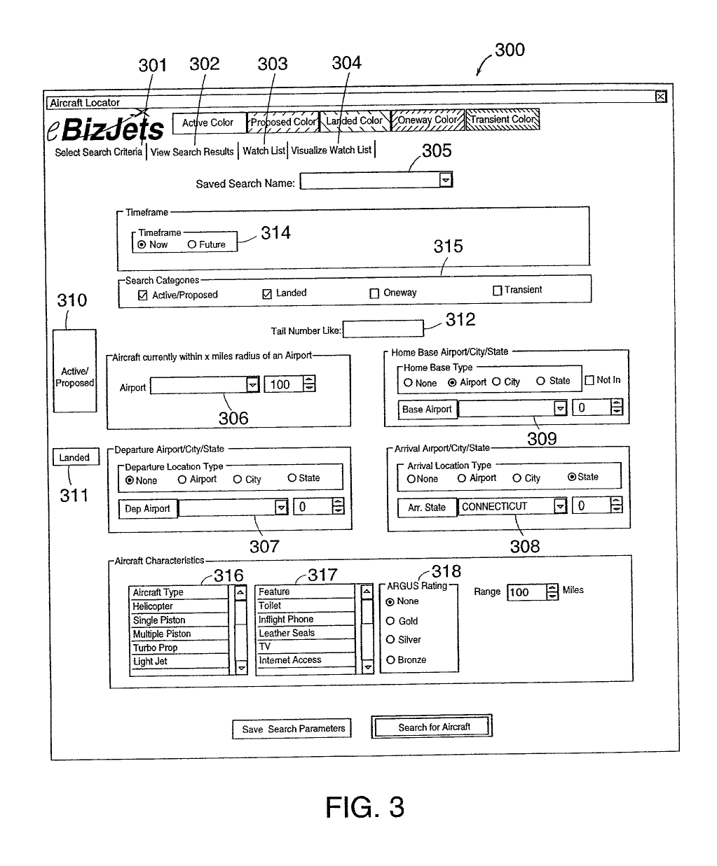

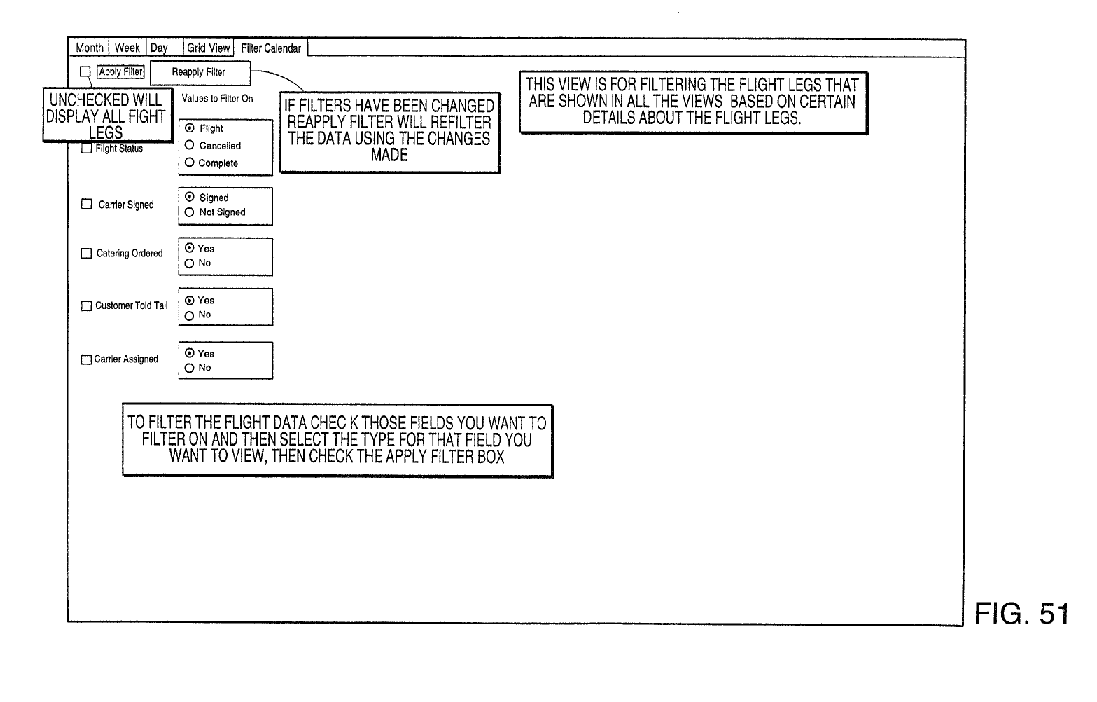

FIG. 3 is an illustration of an aircraft locator interface for conducting a search using a search and notification module in accordance with another embodiment of the invention. The search and notification module is designed such that, by entering aircraft search criteria, contractor personnel may alleviate themselves of the burden of constantly tracking aircraft. An aircraft search can be performed in a number of modes including an “on-demand” mode and a “real-time” mode. In the real-time mode aircraft searching is performed constantly. An on-demand search executes an aircraft search at a given moment on a one time basis. (However, conducting an on-demand search does not prevent a user form saving the search criteria and re-executing the search at pre-determined intervals.) A real-time search emulates a user re-executing an on-demand search at pre-determined intervals. In this manner, a user may automatically be notified that a new aircraft which satisfies the search criteria has been located. The search criteria for an aircraft search may include: aircraft tail number; desired time frame of the search; search categories (including flight statuses such as active, proposed, landed, one-way and transient); current position of desired aircraft, base airport location; departure airport location, destination airport location, desired aircraft type; desired aircraft features, desired ARGUS rating of aircraft; and desired aircraft range. Additionally, each of the criteria entered for the search may take one or more values. Thus, a user may select two suitable aircraft types as is shown in the embodiment of FIG. 51.

The interface 300 of FIG. 3 enables a contractor or contractor personnel to view all data related to flight legs that need aircraft, all data related to flights that have been assigned aircraft, and all data related to flights that have been canceled for each day, each week, each month, or any other time period. The interface 300 provides an electronic link to a module which provides an interface 301 for selecting search criteria, a module which provides an interface 302 for viewing search results, a module which provides an interface 303 for creating a watch list for designating particular aircraft to be tracked, and a module which provides an interface 304 for viewing the aircraft tracked via the watch list. As noted above, the search criteria module 301 may also provide an interface 310 for searching for aircraft that have an active or proposed flight status and an interface 311 for searching for aircraft having a landed status. Each of the interfaces 310 and 311 may include a field 305 for entering a search name in order to save search results, a field 306 for entering the name of an airport in order to search for aircraft within a designated radius of the airport, a field 307 for entering the name of a location (airport, city or state) from which a particular aircraft departed, a field 308 for entering the name of a location (airport, city or state) to which a particular aircraft is scheduled to arrive, a field 309 for entering the name of a home base location for an aircraft (airport, city or state), a field 312 for entering a tail number associated with an aircraft, and a field 313 for entering a range, in miles, over which the search should be conducted. The interfaces 310 and 311 may also provide fields 314 for designating a time frame associated with the search, fields 315 for designating one or more flight status categories associated with the search, fields 316 for designating an aircraft type associated with the search, fields 317 for designating feature associated with an aircraft or flight 317, and fields 318 for designating one or more ARGUS ratings associated with an aircraft.

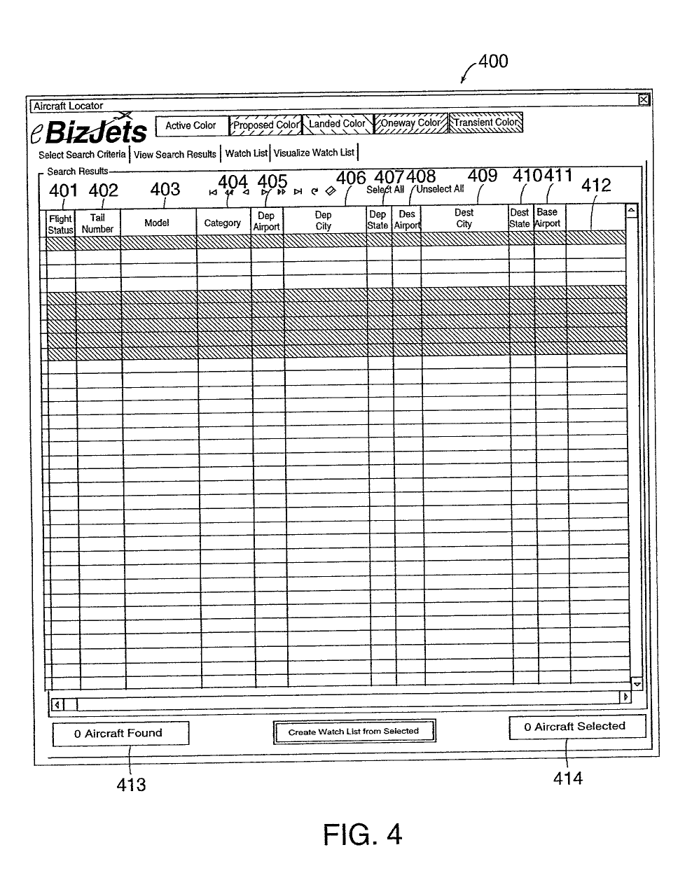

FIG. 4 is an illustration of an interface by which a user may view the results of the search conducted in accordance with module 302 of the embodiment of FIG. 3. The interface 400 includes color-coded fields for displaying a flight status 401, a tail number 402, an aircraft model number 403, an aircraft type category 404 (such as heavy jet, turbo propeller aircraft, multiple piston aircraft, etc.), the name of an airport from which an aircraft departed 405, a name of a city from which an aircraft departed 406, a name of a state from which an aircraft departed 407, a name of a destination airport 408, a name of a destination city 409, a name of a destination state 410, a base airport for an aircraft 411, the name of the city of the base airport 412 and other pertinent information. The interface 400 may also include fields for displaying the number of aircraft found by the search 413 and the number of aircraft selected via the interface 400 for further tracking 414.

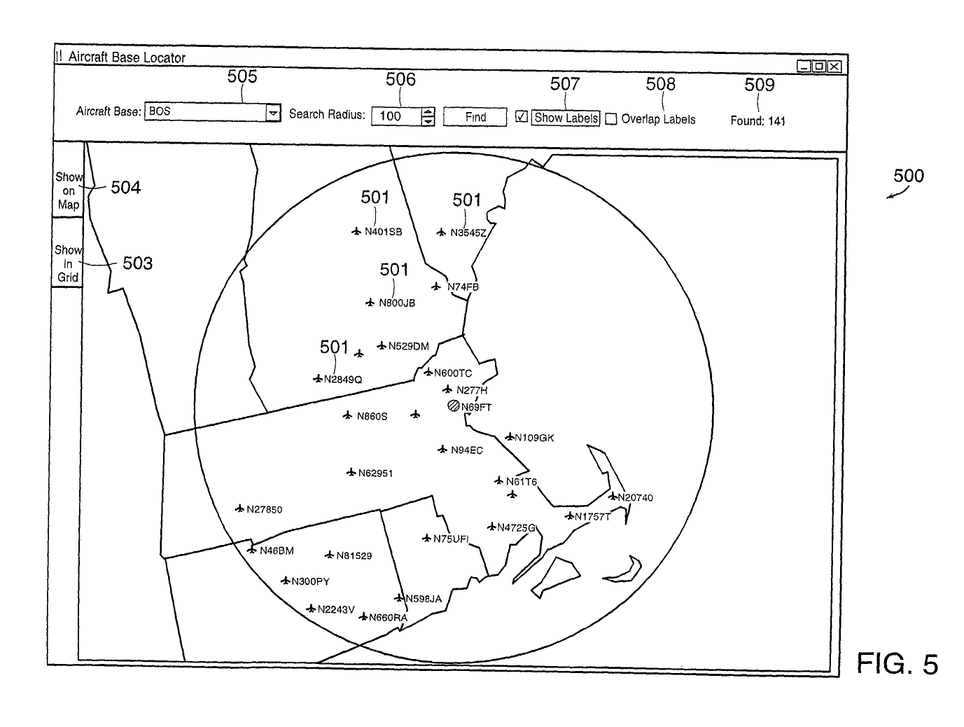

FIG. 5 is an illustration of a aircraft location display interface in accordance with the embodiment of FIG. 3. The aircraft location display interface 500 displays the location of all the aircraft located using the interfaces of FIGS. 3 and 4 in, for example, the form of tail numbers 501. The aircraft location display interface 500 includes a modules 503 and 504 by which a contractor or other user may choose to view the display in grid form (503) or map form (504). The aircraft display interface 500 may also include a field 505 for entering and displaying the name of a base airport for an aircraft, a field 506 for entering and displaying a geographical radius over which the search was conducted, and field for designating that labels (here in the form of tail numbers) may be shown 507 or overlapped 508. The aircraft locator display interface may also include a field 509 for displaying a number of aircraft located as a result of a search.

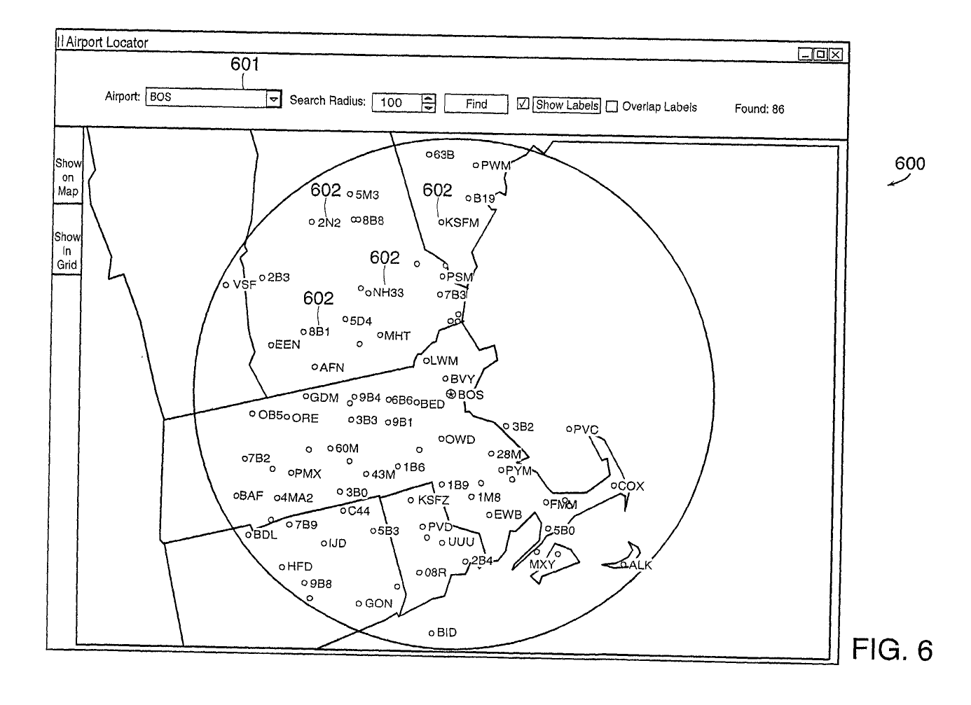

FIG. 6 is an illustration of airport locator display interface in accordance with the embodiment of FIG. 3. The airport locator display interface 600 is similar to the aircraft locator display interface 500 in all regards except that it is used to display the locations of airports, designed by an airport codes, for example airport codes 602, that provide connections for flights in association with a particular airport designated by the contractor. The airport locator display interface 600 includes a field 601 for entering and displaying the name of the particular airport designated by the contractor.

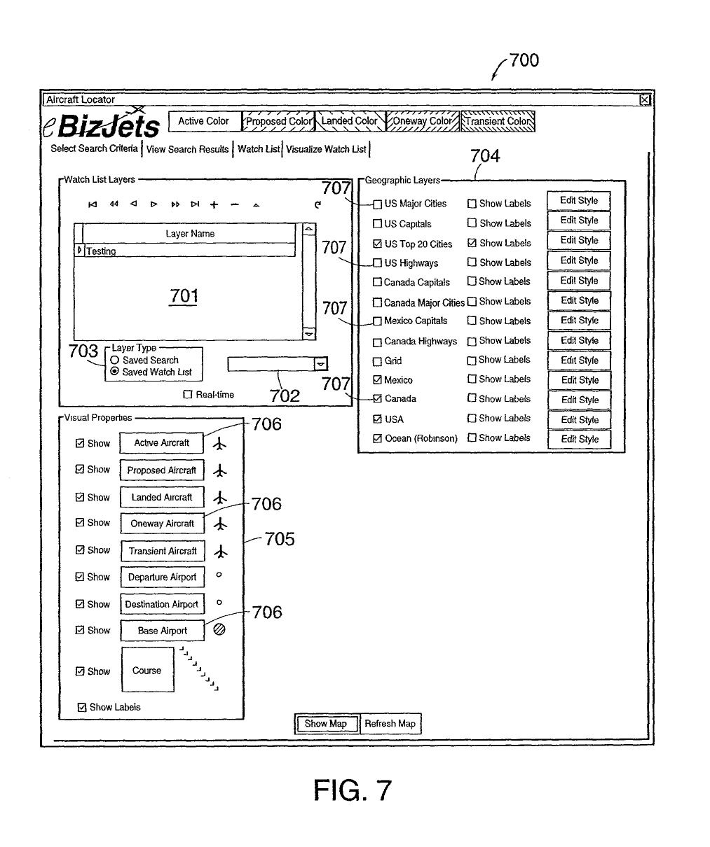

FIG. 7 is an illustration of a graphical user interface for tracking one or more aircraft in accordance module 303 of FIG. 3. The interface 700 includes a field 701 for entering a layer name indicating a span of information to be tracked, a field 702 for entering a name of the person requesting the track, and a field 703 for indicating a layer type (such as “saved search” or “saved watch list”). The interface 700 may also include a field 704 for indicating the geographical layer or region over which the tracking should occur (such as major US cities, Mexico, Canada, etc.). A contractor, contractor personnel or other user may indicate one or more geographical layers or regions, for example regions indicated at 707, over which to track a flight. The interface may further include a field 705 for indicating what properties, such as properties 706, the user would like to see displayed as a result of the tracking request (such as destination airport, departure airport, base airport, active aircraft, proposed aircraft, landed aircraft, one-way aircraft, transient aircraft, labels, and course.)

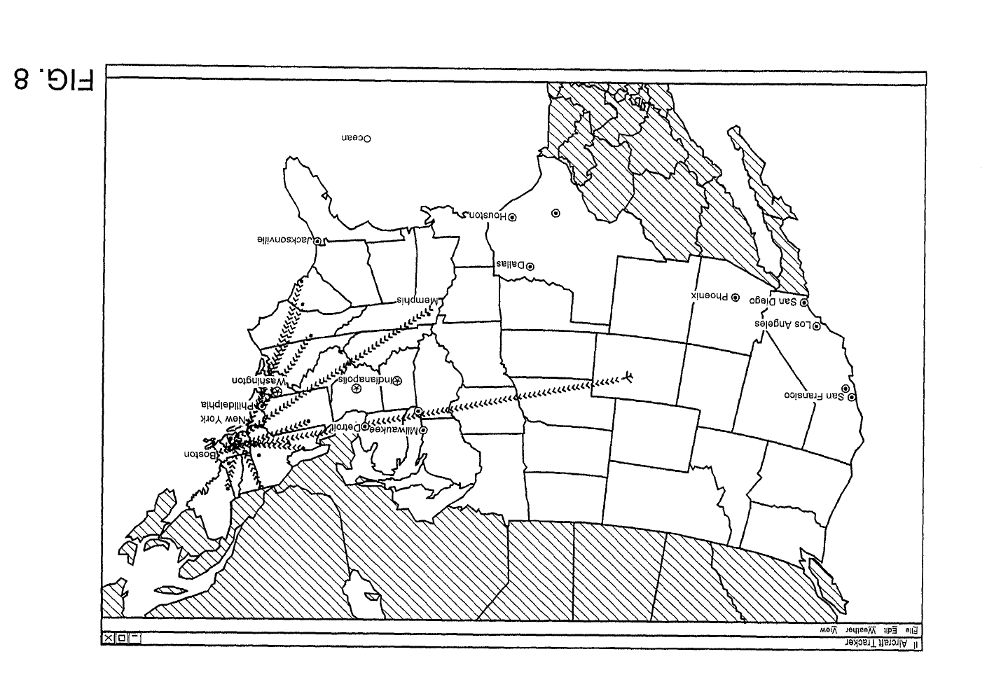

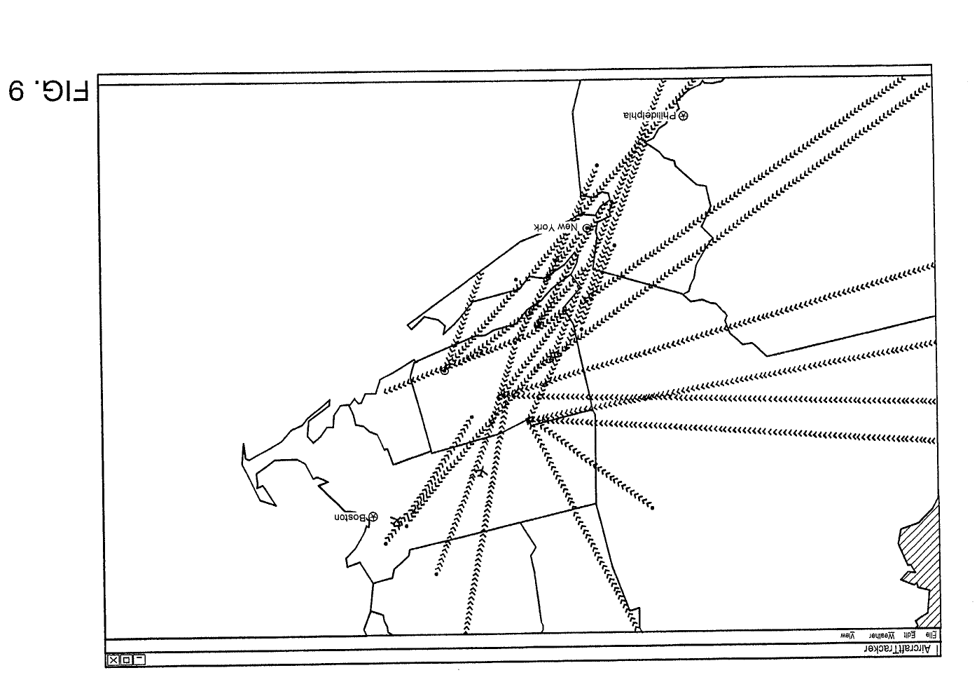

FIG. 8 is an illustration of an interface for viewing the aircraft tracked in accordance the embodiment of FIG. 7 and module 304 of FIG. 3. According to this embodiment, a contractor or other user may view one or more aircraft tracked according to information entered through the interface of FIG. 7 over a large area, such as the United States. If a user has indicated a particular geographical region, the region will be displayed as is illustrated by FIG. 9.

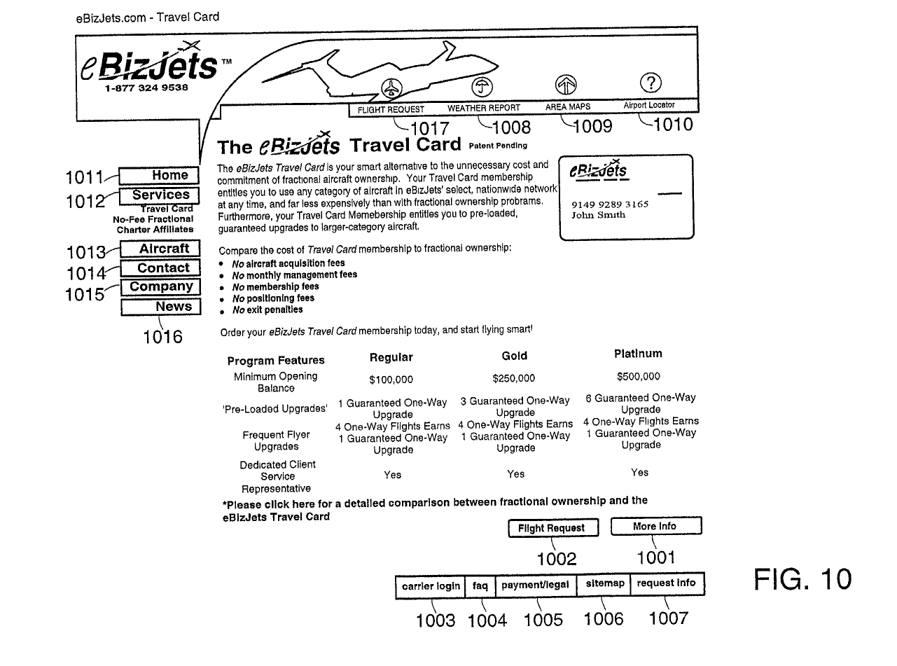

FIG. 10 is an illustration of a web page for providing a graphical user interface to a customer in accordance with another embodiment of the present invention. The graphical user interface 1000 may provide communication links to a plurality of modules, any one of which may be accessed by clicking on one of a plurality of links 1001-1016. The modules provide graphical user interfaces for among other things, displaying information related to the private air travel contractor, via links 1011-1016 and 1006-1007, including travel card information (through link 1012), and information relevant to a private air travel customer's personal account. A customer may also access information regarding flight requests through link 1017, information regarding weather reports through link 1008, and information regarding area maps via link 1009. A customer may access an airport locator through link 1010.

Additionally, a customer may access a module that provides a request interface containing fields for entering private aircraft travel request information through link 1002, and access another module that provides a payment interface by which a customer may choose a payment method or access legal information about the private air travel business through link 1005. A customer may also enter payment information through the interfaces accessed through link 1005. Other links may be included provide interfaces that will allow a customer to update his or her customer profile information, such as their contact information and catering and flight preferences. Links may also be included to provide interfaces that enable a travel card customer to quickly enter new flight requests and select origin, destination, and aircraft preferences as well as the number of passengers and catering preferences for each leg of a flight. Customers may also be provided with links that enable each customer to track an aircraft or flight. A customer may access an interface that displays frequently asked questions and the answers to those questions through link 1004.

The interface 1000 may also include an aircraft service provider login to the contractor's system through link 1003. Via this link, an interface may be provided to enable an aircraft service provider to update the aircraft service provider's profile information and enter future open flight legs and transient flights which will then be immediately available to contractor personnel. Link 1001 may provide access to an interface that includes further information about private air travel.

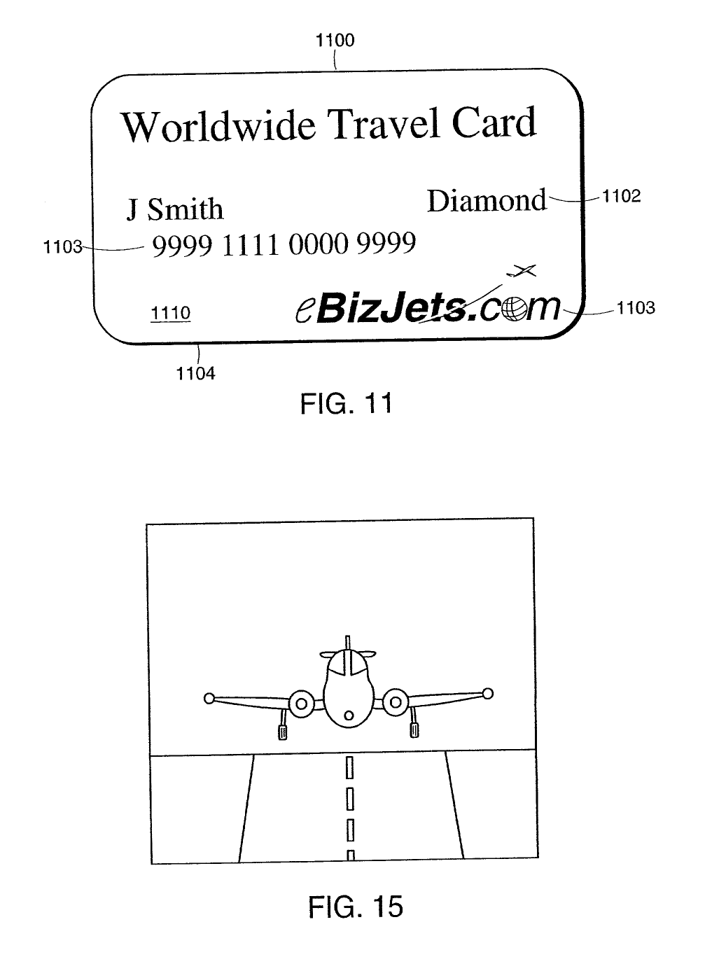

FIG. 11 is an illustration of a travel card in accordance with an embodiment of the present invention. A travel card 1100 includes a first face 1110 including an identification number 1101 thereon for identifying a customer authorized to use the travel card 1100 and a designation 1102 representing a pre-purchased allotment of aircraft service. The designation 1102 may be in the form of a color, such as gold or platinum, or as shown here, it may be embossed on the first face 1110 of card as is the contractor's name 1103. The card 1100 may also include, on the first face 1110 or on a second face (not shown) a designation representing a discount rate for private aircraft service or a designation representing a pre-determined number of private aircraft service upgrades that are redeemable at the option of the customer. The first face 1110 or second face may also include a magnetic strip that enables the card to be read by a magnetic strip reader. In a related embodiment, the card 1100 may also include a processor and memory 1104 (generally disposed between the first face 1110 and the second face).

In one embodiment, the memory of the travel card 1100 may retain data pertinent to the customer's private aircraft service preferences, such as entertainment preferences, dining preferences, aircraft preferences, post-flight travel preferences (including hotel accommodations, car rentals, etc.) and pre-flight travel preferences and accommodations (including flight insurance, limo service, etc.). The memory may also retain data pertinent to the customer's medical preferences, including the name of a preferred primary care practitioner or hospital and treatments. In related embodiments, the processor may include program code for establishing a communication link to a computer network when the code is read by a computer on an aircraft, in a car, at home or in a hotel room. The communication may include an electronic link to the Internet, or an electronic link to a private air travel service contractor via the Internet or other network.

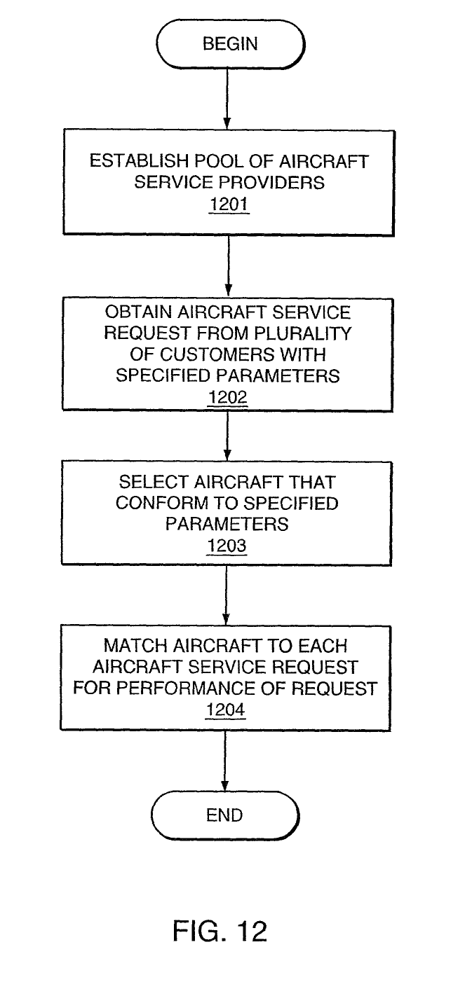

FIG. 12 is a flow chart illustrating a method for providing private air travel in accordance with an embodiment of the present invention. A contractor establishes 1201 a pool of aircraft service providers. Though the pool of aircraft service providers may be limitless, it is preferred to direct most private air travel requests to a smaller subset of preferred aircraft service providers within the pool. This insures maximum customer satisfaction in that the aircraft service provider service is known to be reliable and safe. One or more aircraft service requests are obtained 1202 from one or more customers. The customer supplies certain specified parameters such as destination, aircraft type, preferred time of arrival, catering requirements, and entertainment preferences (e.g., music the customer would like to listen to on the flight, movies the customer would like to watch on the flight, reading material the customer would like to have on the flight), etc. An aircraft is selected 1203 from the pool of aircraft service providers in accordance with the parameters supplied by the customer. The aircraft is matched 1204 to the aircraft service request for the performance of the request in a manner that minimizes the occurrence to passenger-less flights as described in greater detail above.

FIG. 13 is a flow chart illustrating the method of FIG. 12 detailing pre-flight procedures. A customer request is received 1301 by the contractor through any communication medium. The request may come via a graphical user interface, such as a web page, via a facsimile machine, via e-mail, via a telephone or via the customer's personal appearance at the contractor's place of business. If the customer is a travel card program participant, the customer will have been provided with a pre-purchased allotment of private air travel and customer specific flight itineraries will be obtained 1302 from the database 120 and updated if necessary.

As discussed above with respect to FIG. 11, as a member of the travel card program the customer may pre-purchase allotments of private air travel having several different values. For example, the customer may pre-purchase $100,000 of private air travel, $250,000 of private air travel, or $500,000 of private air travel. These three different allotment values may correspond to a travel card that is silver, gold and platinum respectively. Further, by participating in the travel card program the customer may be guaranteed pre-determined hour flight discount rates which are dependent upon the allotment value. The flight discount rates may be determined by the type of aircraft the customer prefers, i.e., a light weight aircraft may have one hourly rate associated with it, a mid-size aircraft may have another hour discount rate associated with it, and a heavy aircraft may have a third discount rate associated with it.

Further, a customer may be guaranteed a predetermined number of flight upgrades which may also be determined by the value of the pre-purchased allotment. Similarly, by participating the travel card program, a customer may be guaranteed a pre-determined number of frequent flyer upgrades and a dedicated customer service representative, both of which may be determined by the value of the pre-purchased allotment of private air travel. The guaranteed hourly flight rate discounts, the pre-determined flight upgrades, the frequent flyer upgrades, and the identification of the dedicated customer service representative may be indicated on a first or second face of the travel card in the manner discussed above. Additionally, the discounts, upgrades and dedicated customer service representative identification may be indicated by information read by a magnetic strip reader, or by information stored in a processor and memory which may be included with the travel card. If the customer is not a travel card program participant, customer specific flight itineraries are obtained 1310 from the customer and entered into the database 120.

The contractor will execute a comprehensive search 1303 to find a suitable aircraft that might be available to make the trip. The contractor may focus on finding an aircraft that would have made the trip to the customer's preferred destination without passengers or an aircraft that may be sitting idle at the customer's preferred boarding location. The contractor also focuses on finding aircraft and aircraft service providers that have good safety and maintenance records. Additionally, the contractor will consider the aircraft size, the aircraft's comfort, entertainment and engineering features, the aircraft's passenger capacity, and the aircraft's flight range.

A quote based on the customer's requested itinerary (e.g. type of aircraft, entertainment preferences, etc.) is generated 1304 and delivered 1305 to the customer. The quote is generated using a software package, such as NAVPAK, and the contractor's in-house expertise. The customer can reject the quote, accept the quote, or reject the quote and alter the itinerary. When the quote has been accepted, appropriate aircraft is selected 1306 from one or more alternative aircraft service providers. The aircraft is selected with respect to satisfying mission parameters such as the requested itinerary and price, as well as availability of aircraft.

The contractor then secures 1307 the selected aircraft for the flight. This is accomplished by receiving a confirmation from the aircraft service provider that the aircraft is designated for the flight, and may also include a confirmation that the aircraft and/or flight has been insured. If the customer is not participating in a travel card program provided by the contractor, then the customer's personal preferences (itineraries) are also secured in process 1307. Finally, a summary of the flight mission is sent 1308 to the aircraft service provider.

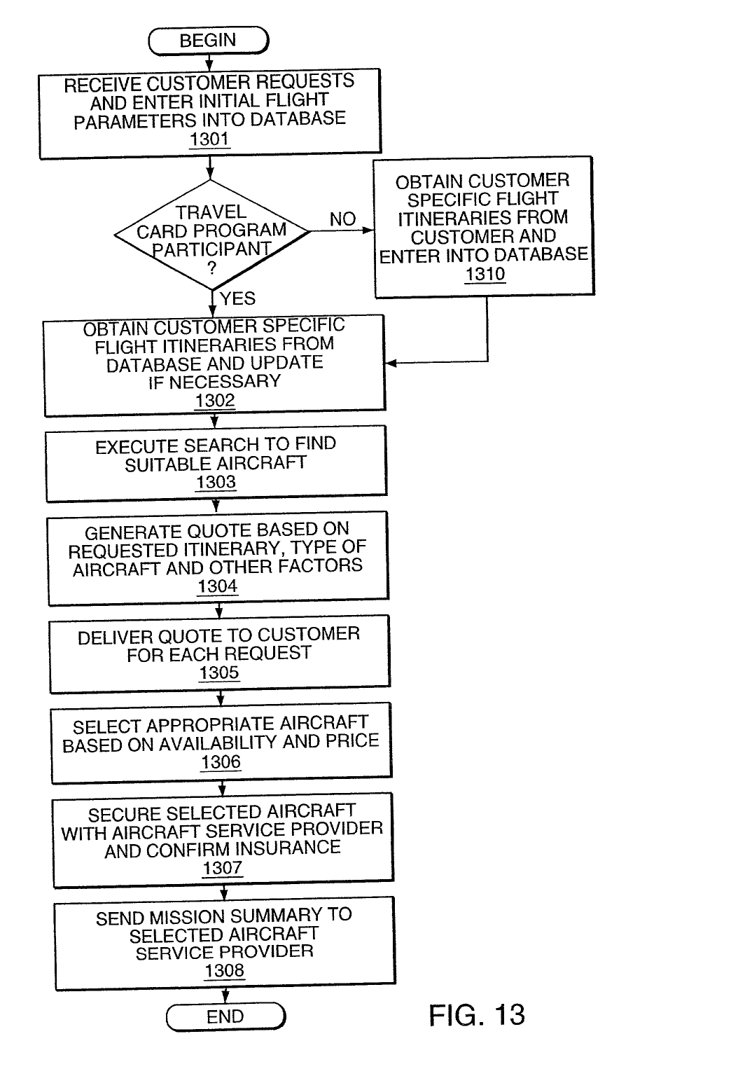

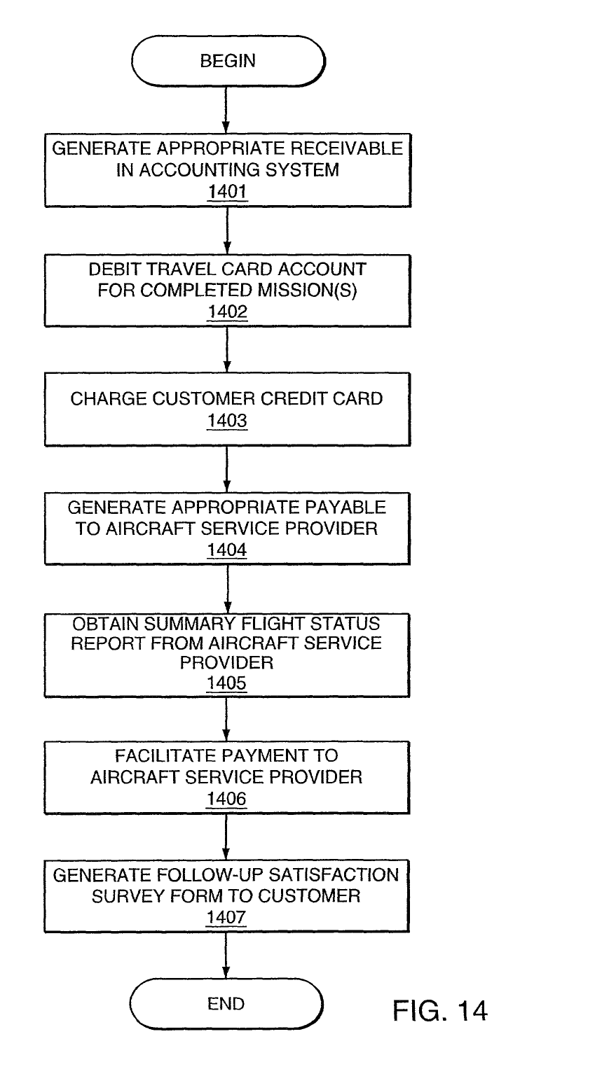

FIG. 14 is a flow chart illustrating the method of FIG. 12 detailing post-flight procedures. The aircraft service provider performs the entire flight mission using the specified aircraft (including flight operations, catering, and aircraft maintenance.) Following performance of the flight mission, an appropriate receivable is generated 1401 in an accounting system. If the customer is participating in the travel card program, the value of the flight mission is debited 1402 from the pre-purchase allotment of private air travel that the customer's card indicates. If not, an invoice may be sent to the customer or a credit card may be charged 1403 directly. An appropriate payable is also generated 1404 to the aircraft service provider and a summary flight status report is obtained 1405. Payment to the aircraft service provider is facilitated 1406 based on the flight status report and a satisfaction survey form is generated 1407 and sent to the customer.

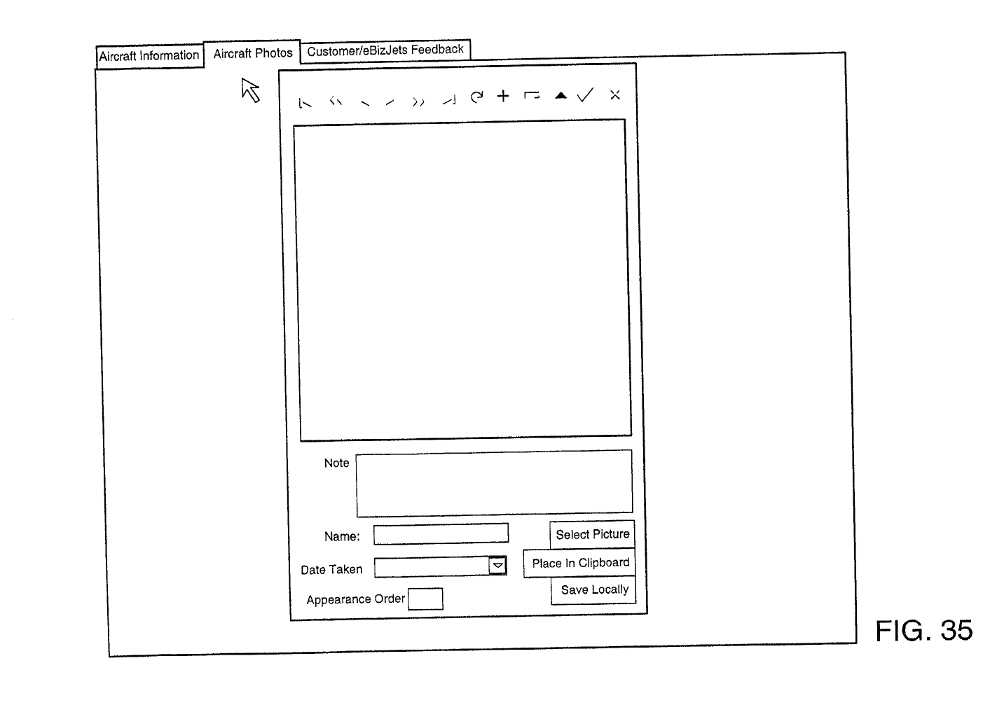

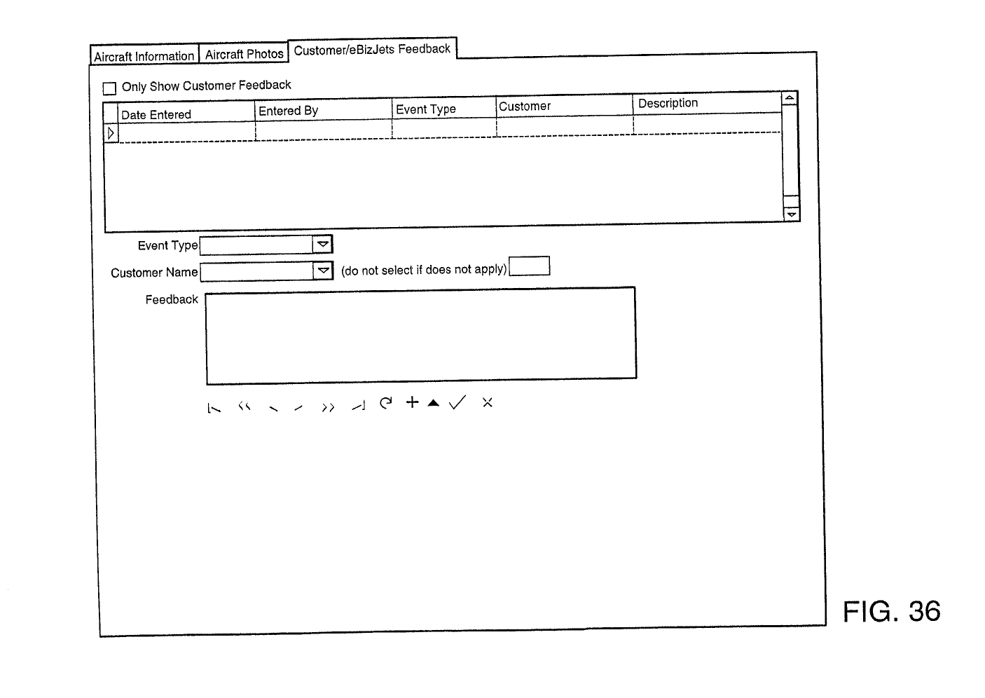

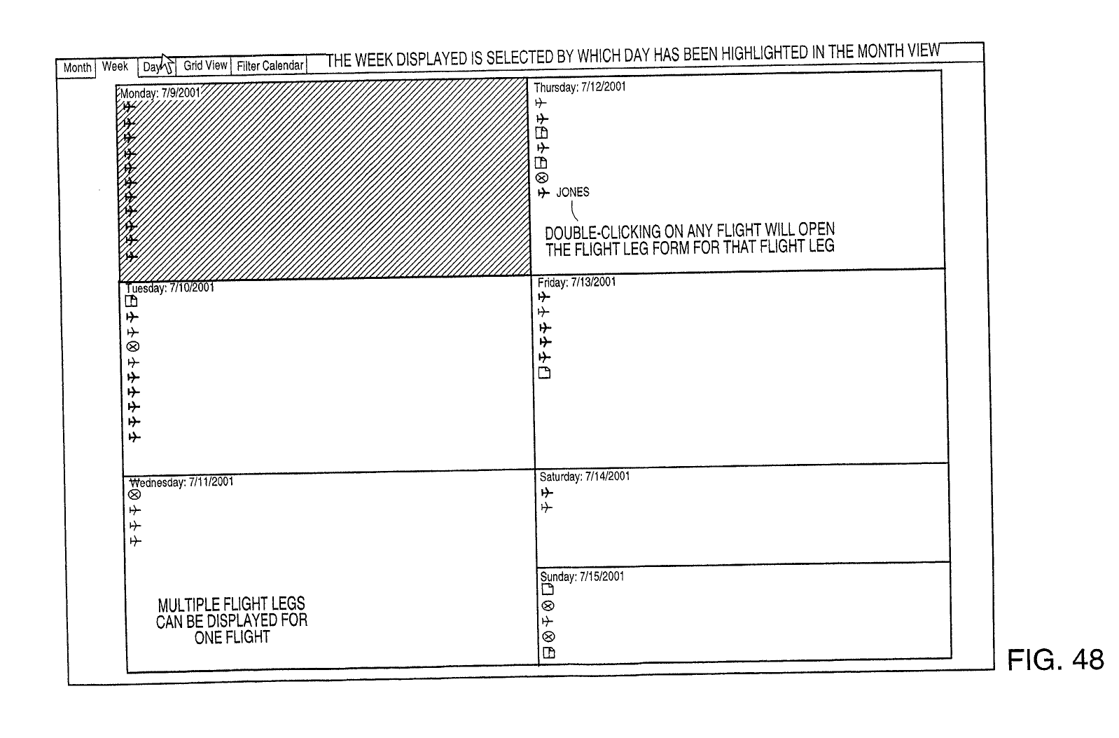

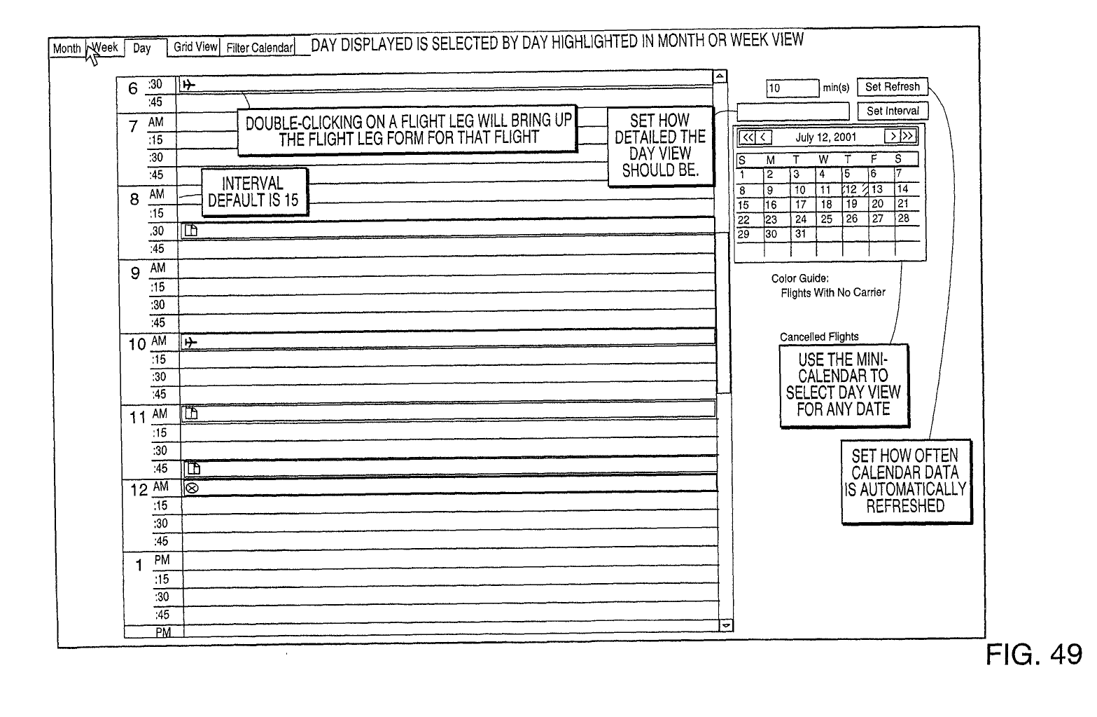

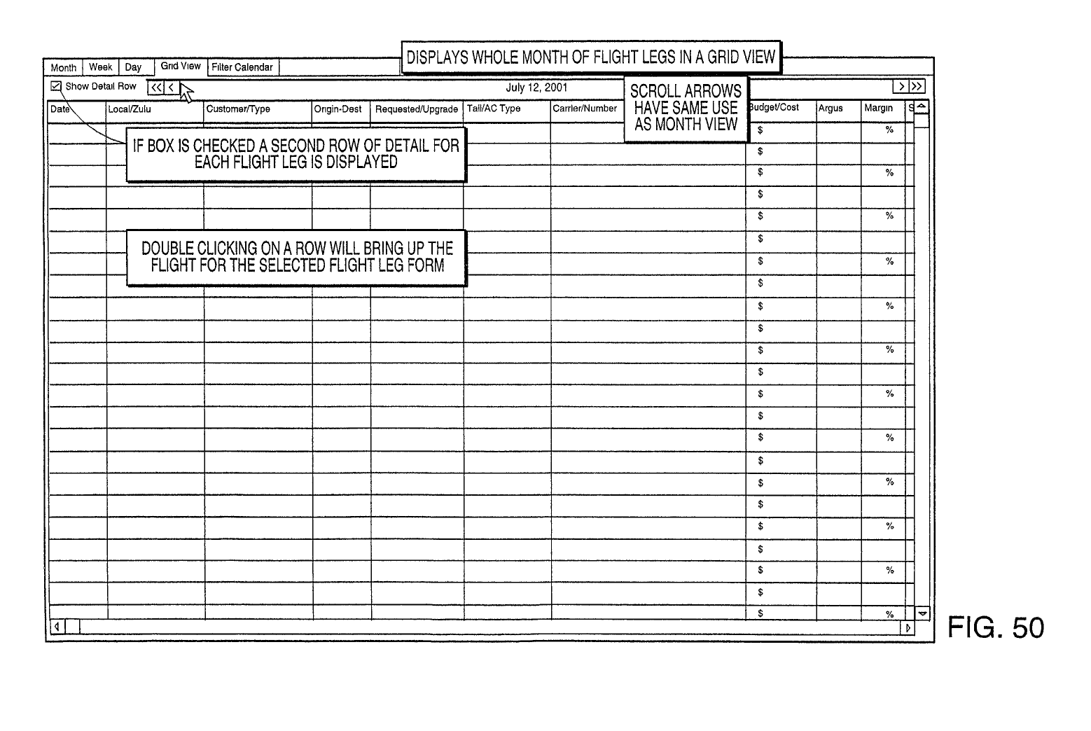

FIGS. 15-52 are graphical user interfaces that may be used in conjunction with a computer based flight center command module in accordance with one embodiment of the invention. Many of the interfaces illustrated in FIGS. 15-52 have been provided with annotations, and are generally self-explanatory. These interfaces provide a contractor, contractor personnel or other user with means for accessing the entities of the database described with respect to FIG. 1 as well as their related attributes.

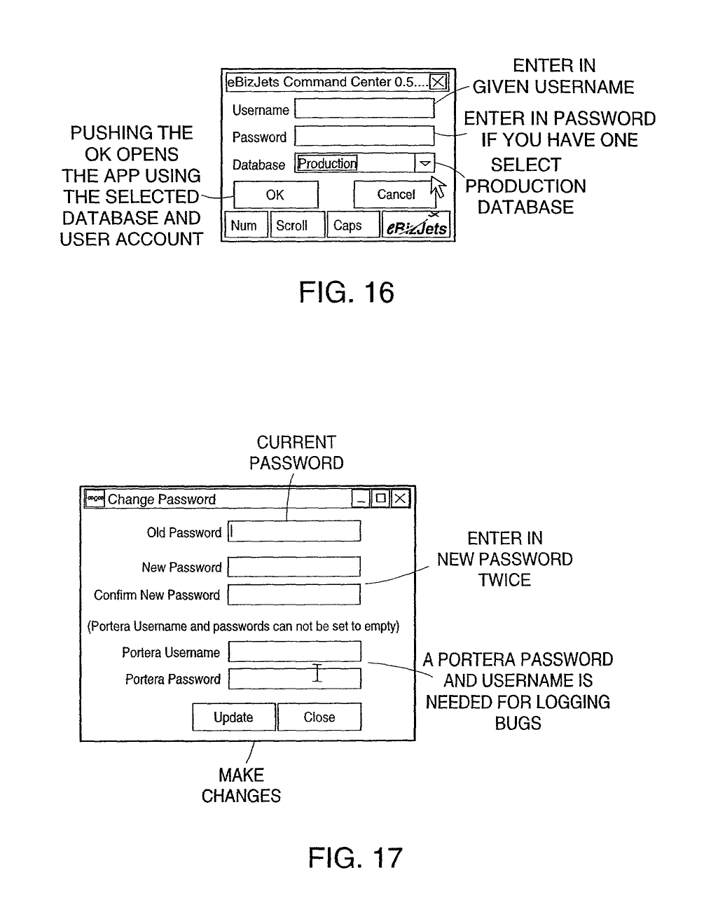

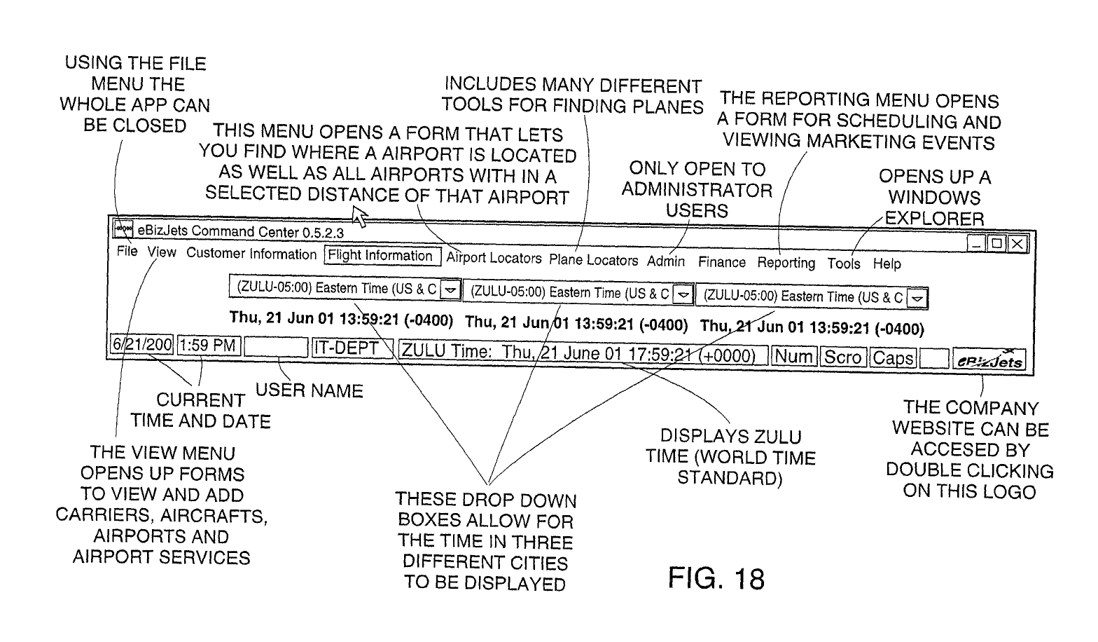

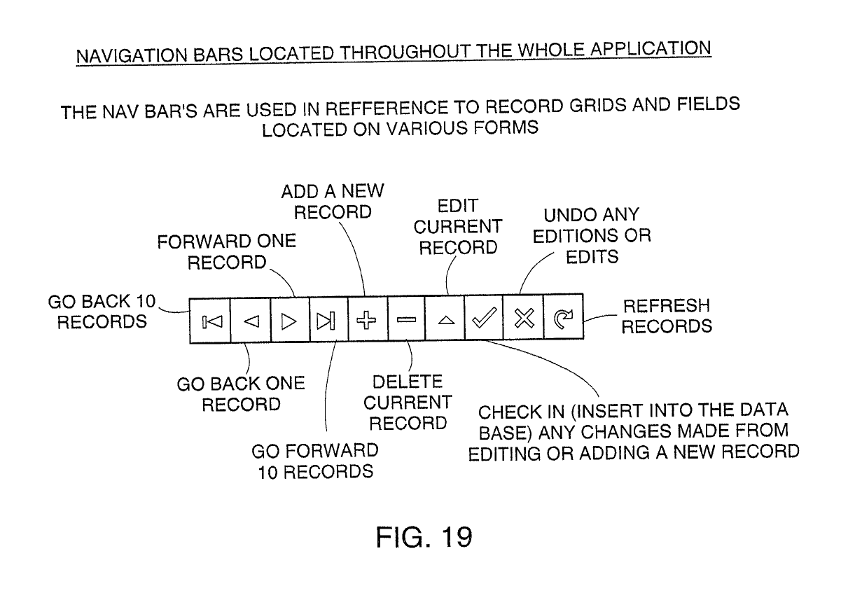

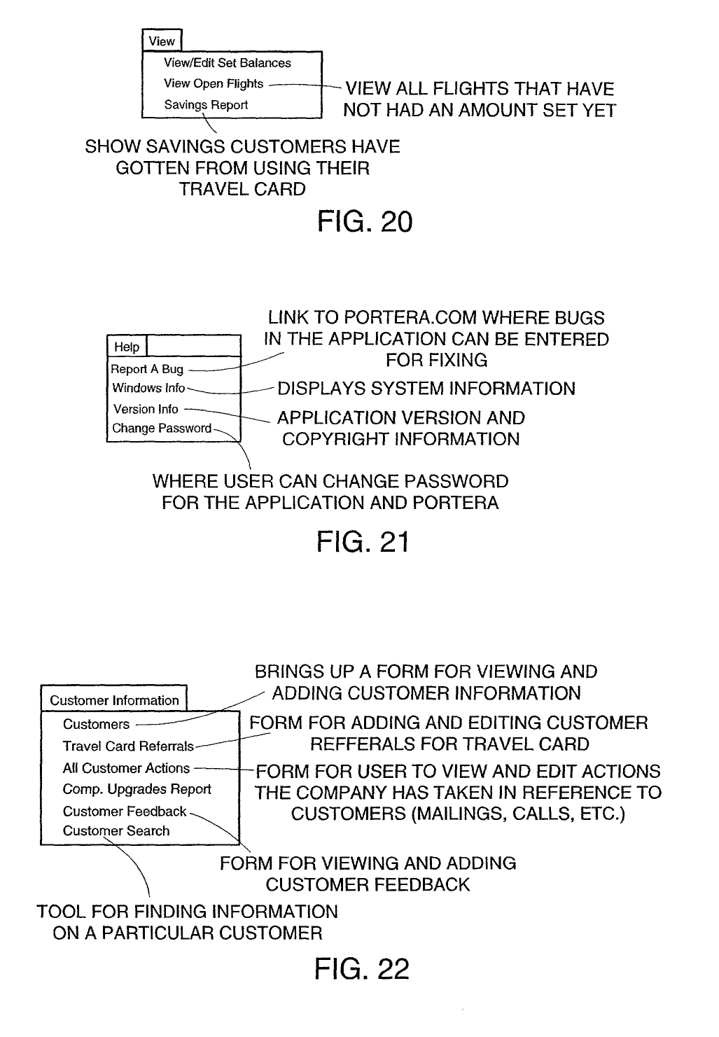

FIGS. 15-21 are illustrations showing interfaces by which a user may login to the private aircraft contractor's system and navigate through the command center application. FIG. 15 is an illustration showing login icon and FIG. 16 is an illustration showing a login interface by which a user may login into the command center application by providing a password. The user may also designate a database of the system he or she wishes to access. FIG. 17 shows an interface by which a user may change his or her password and update the new password in the system. (Note that “Portera” is a name used in trade by Portera Systems of Campbell, Calif.). FIG. 18 is an illustration showing a command center application menu of the flight command center module. Via this menu, a user may access customer and flight information, locate airports and planes, create reports and access financing and accounting information. FIG. 19 illustrates navigation bars which may be used throughout the command center application. FIGS. 20-21 are illustrations showing view and help pull down menus associated with the interface of FIG. 18 and particular to the command center application. (Again, note that “Portera” is a name used in trade by Portera Systems of Campbell, Calif.).

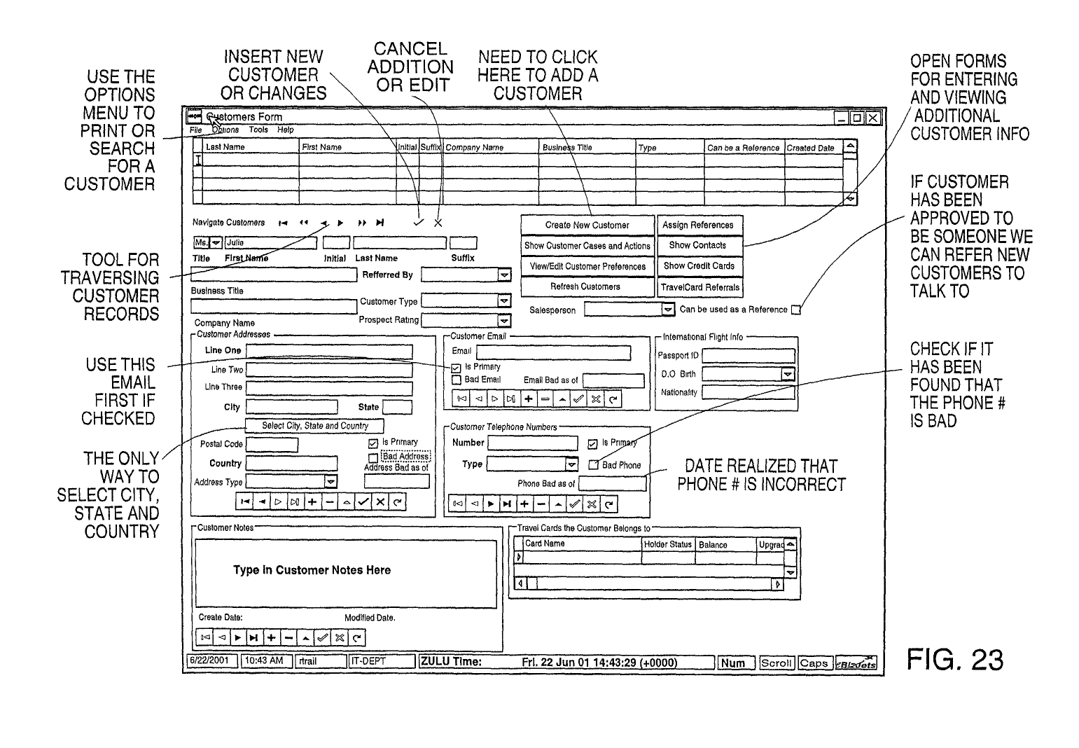

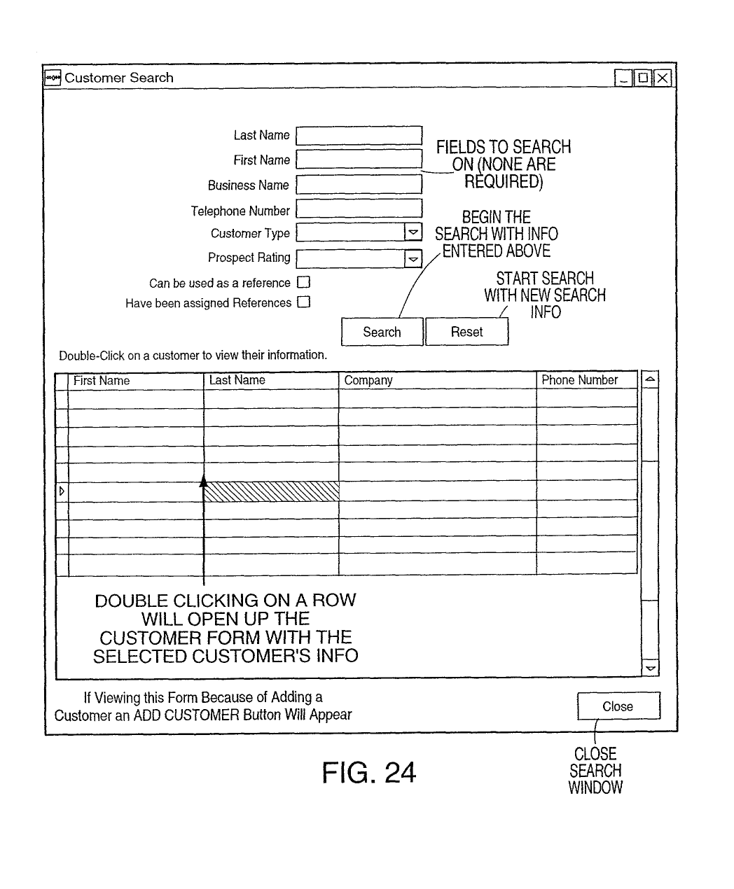

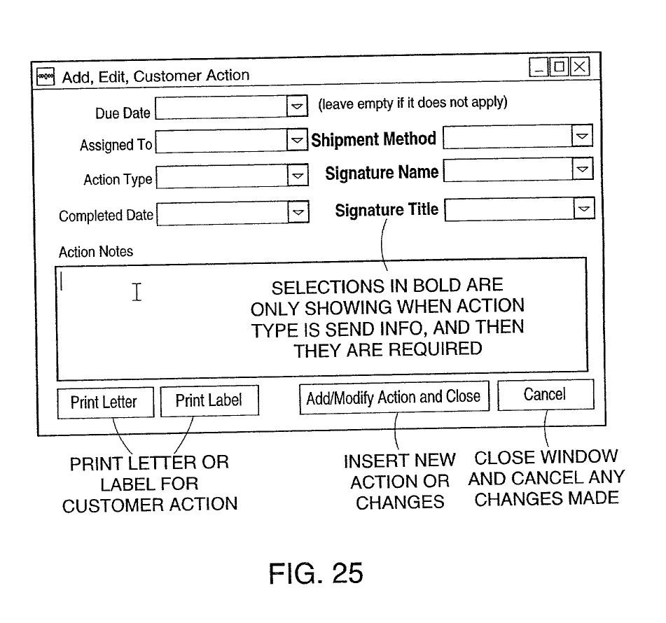

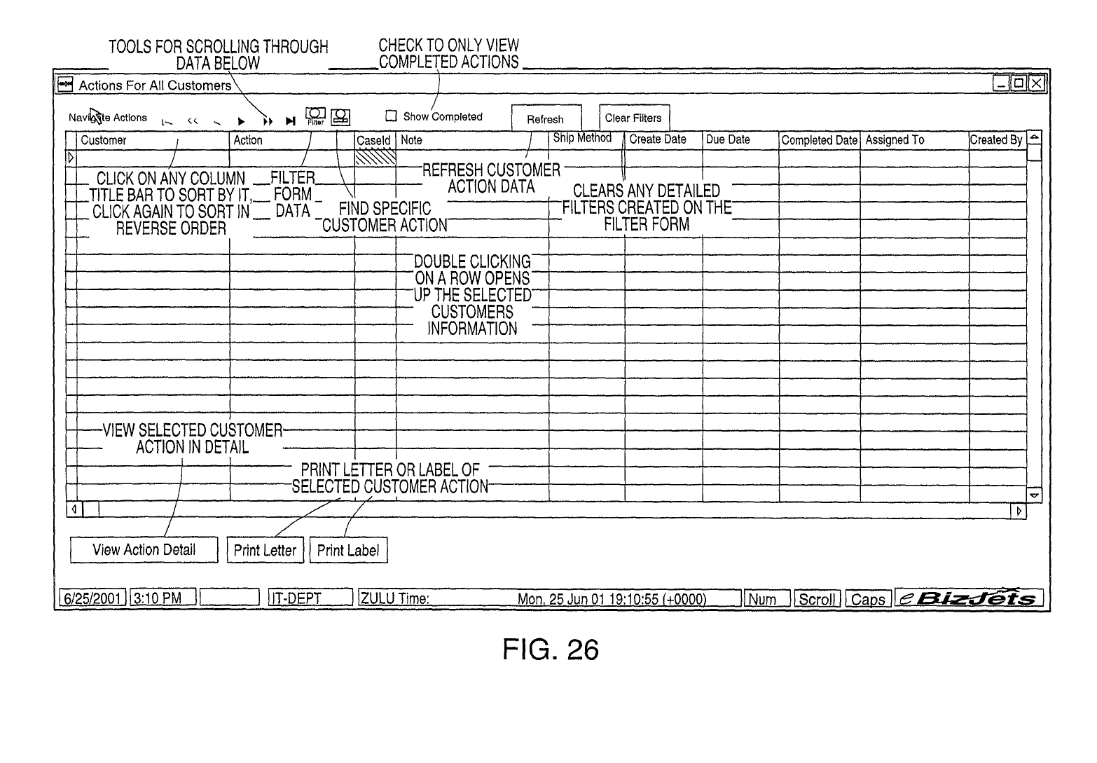

FIG. 22 is an illustration showing a customer information pull down menu associated with the interface of FIG. 18 by which a user may access customer information, travel card information and conduct a customer search. By clicking on “customer” a user is given access to a customer information interface, as shown in FIG. 23. Through the interface of FIG. 23, a user may add and edit information related to one or more customers. By clicking on “customer search” in FIG. 22, a user is given access to a customer search interface, shown in FIG. 24. The interface of FIG. 24 enables a user to search for a customer by name, business name, telephone number, customer type, or prospect rating. Double clicking on any name displayed in accordance with the search result will link the user to the individual customer's information profile as shown in FIG. 23. Through the interface of FIG. 25, a user may add or edit a customer action as well as record notes related to the action. The user may also print a letter to be sent to contractor personnel, aircraft service providers, or the customers. Similarly, a user may print label for the action. FIG. 26 shows an interface by which actions for all customers may be viewed. By double clicking on any row, a user may view the details of the customer action.

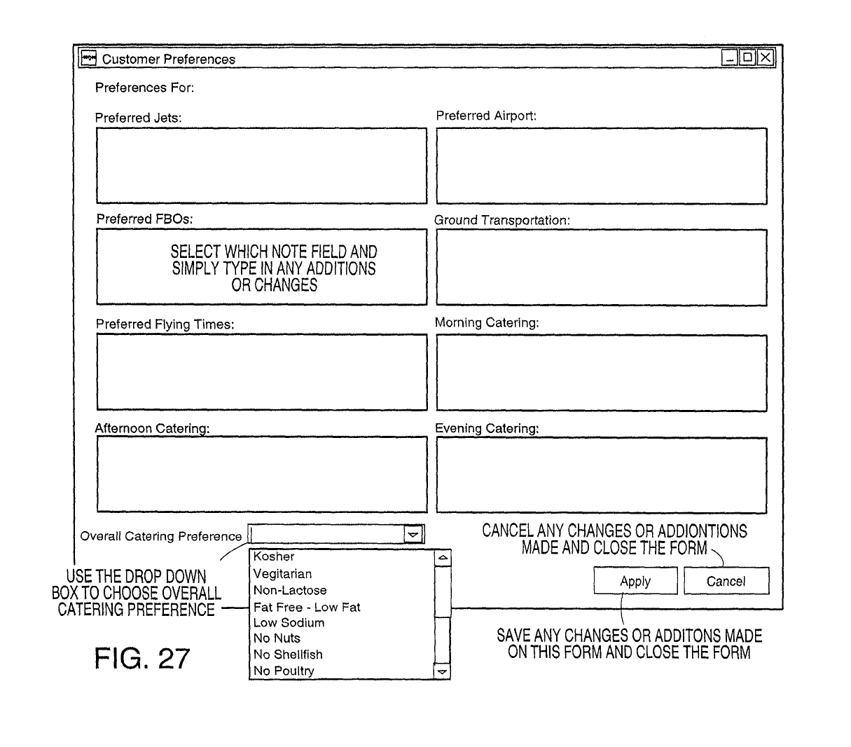

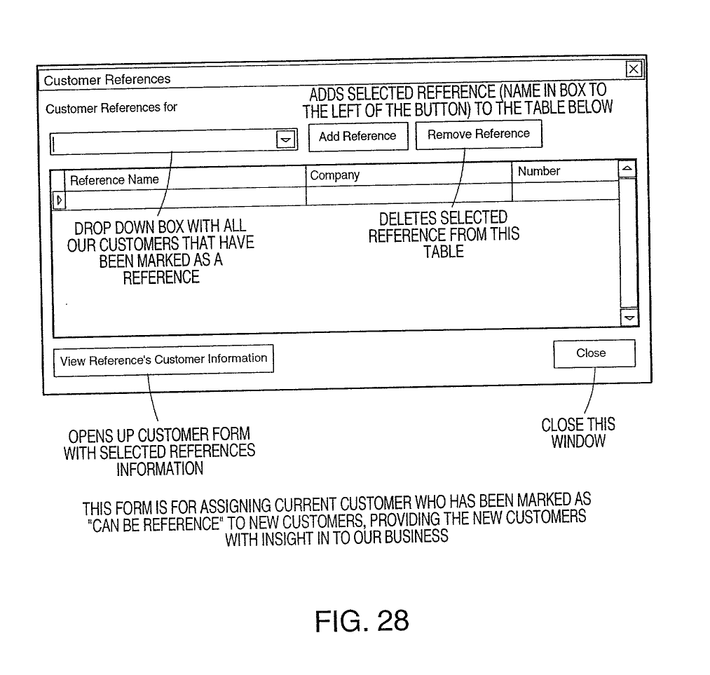

FIG. 27 is an illustration of an interface by which a user may input to the database a customer preferences (including a customer's preferred jet, airport, flying times, mode of ground transportation or and catering needs or desires.) FIG. 28 shows a customer references interface whereby a user may assign a current customer as a reference for new customers to provide the new customer or customers with insights into the contractor's service.

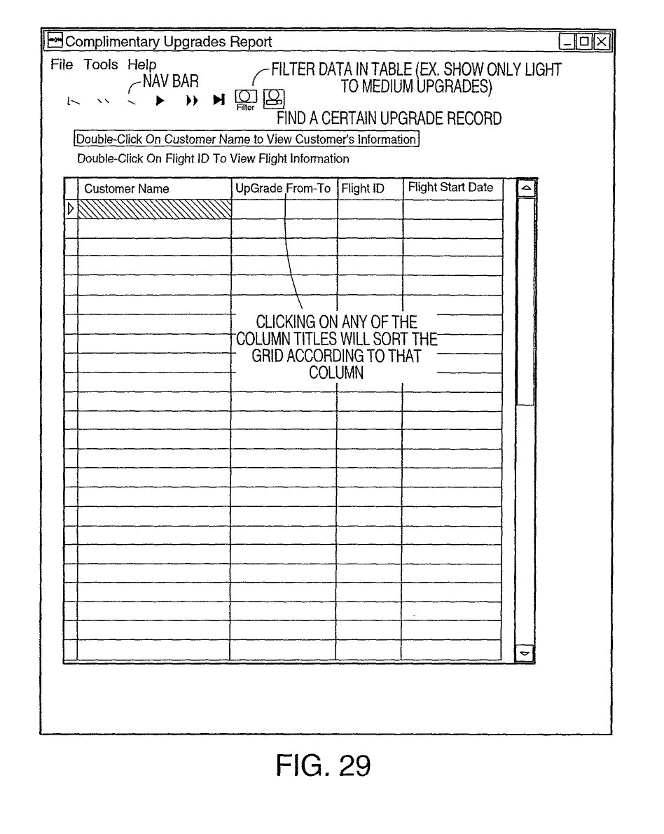

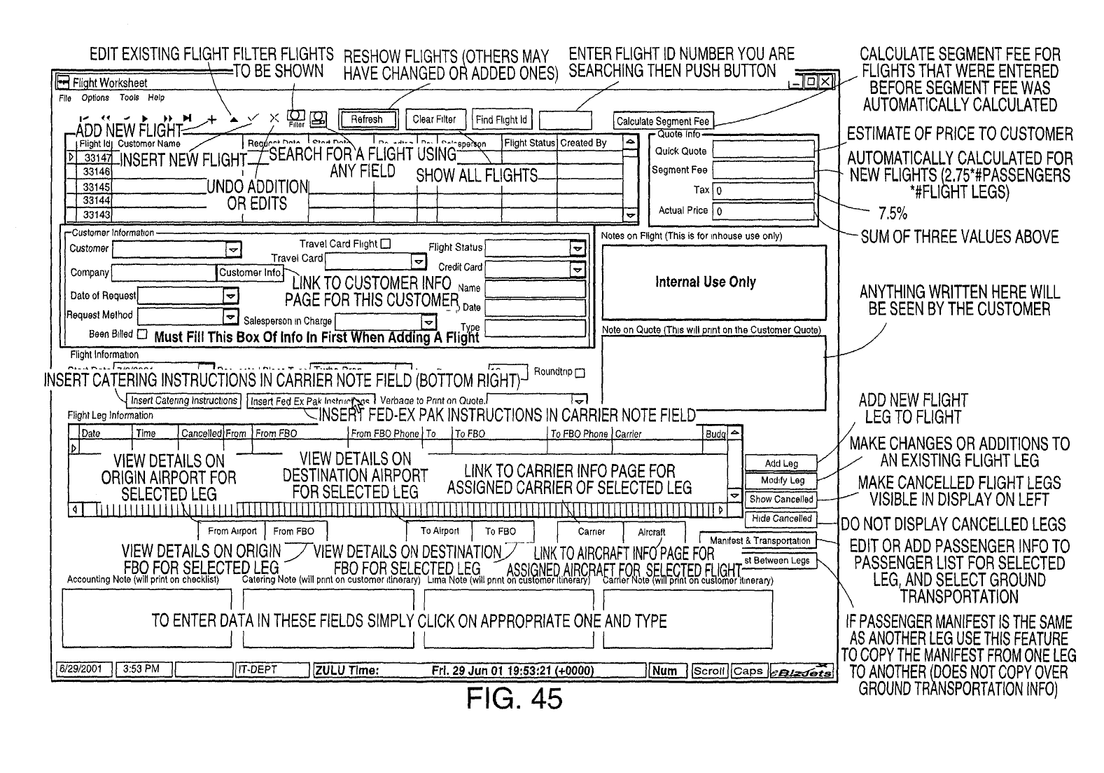

FIG. 29 is an illustration showing a complimentary upgrade report by which a user may upgrade customer's aircraft. A customer's aircraft may be upgraded from a light jet to a medium or heavy jet. From a turbo propeller plane to a jet, etc. Double clicking on a customer name will electronically link a user to a customer information interface by which the user may view and edit customer information through another interface (such as the interface shown in FIG. 23. Double clicking on a flight ID will electronically link the user to a flight information interface by which the user may view and edit flight information through another interface, such as that shown in FIG. 45.

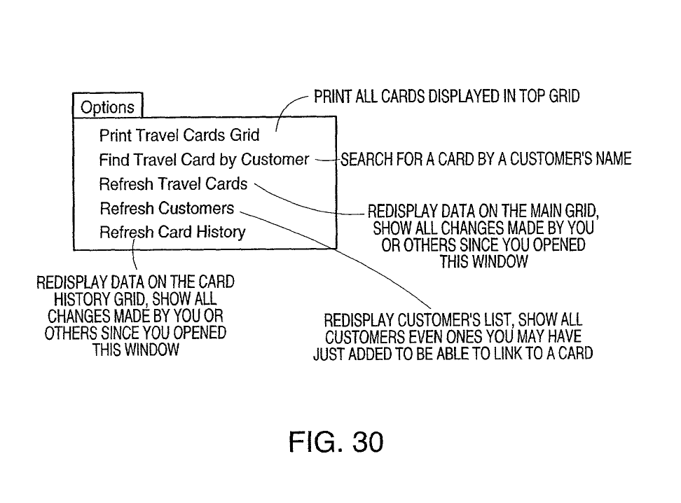

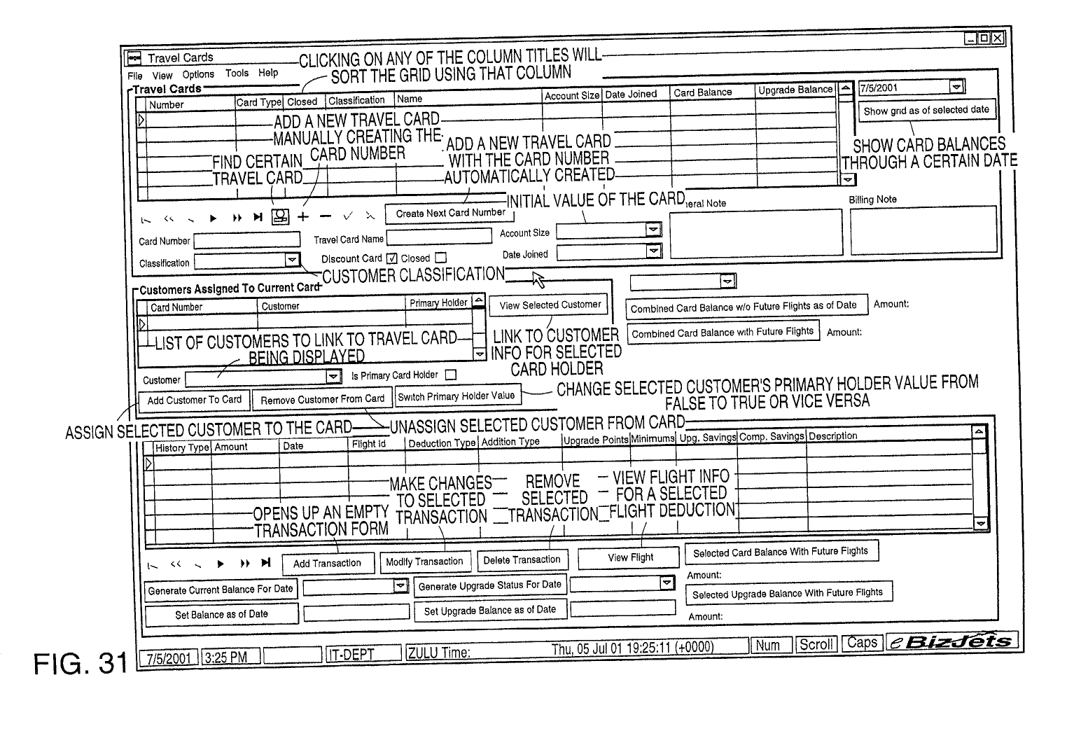

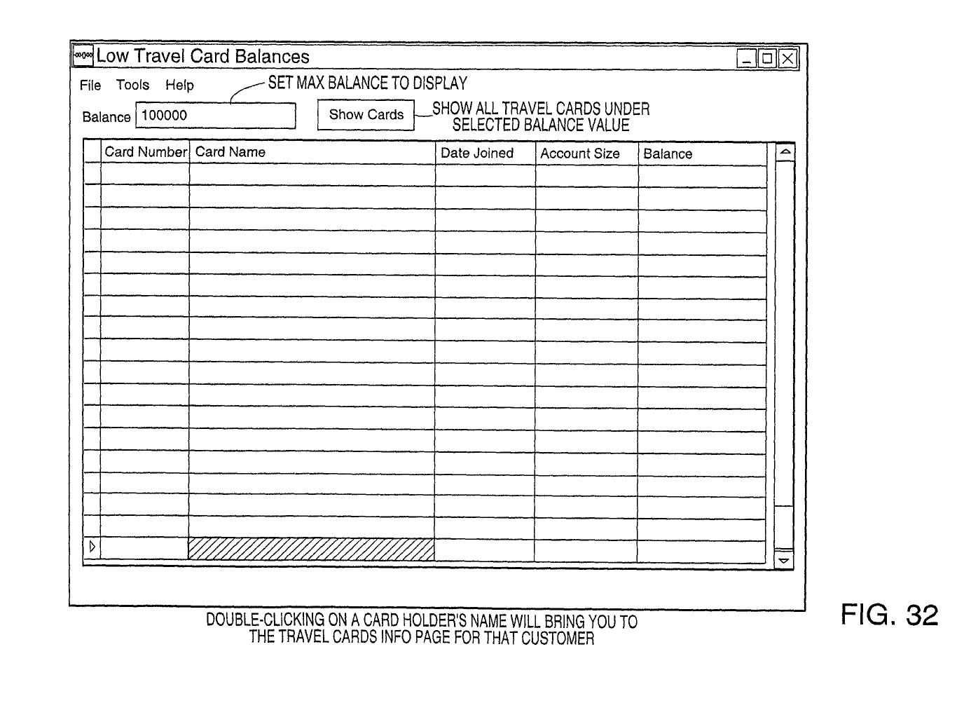

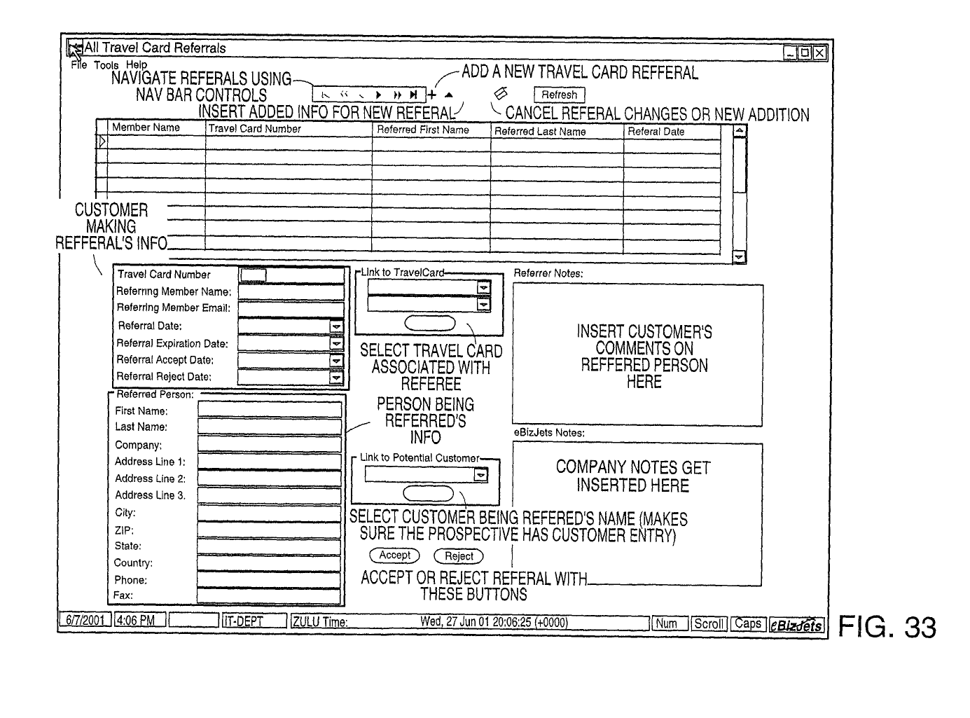

FIG. 30 is an illustration showing an pull down menu associated with the interface of FIG. 18 by which a user may print, view or refresh information related to travel cards. FIG. 31 shows a travel card information interface by which a user may add and edit a customer's travel card details and travel card account history. By this interface a user may add and delete new customers for a particular travel card and create a new travel card for a customer. FIG. 32 is an illustration showing a travel card/customer balance information interface, and FIG. 33 shows a travel card referral interface by which a user may add new travel card referrals, record comments from customers regarding a referral, and record contractor personnel notes regarding the referrals.

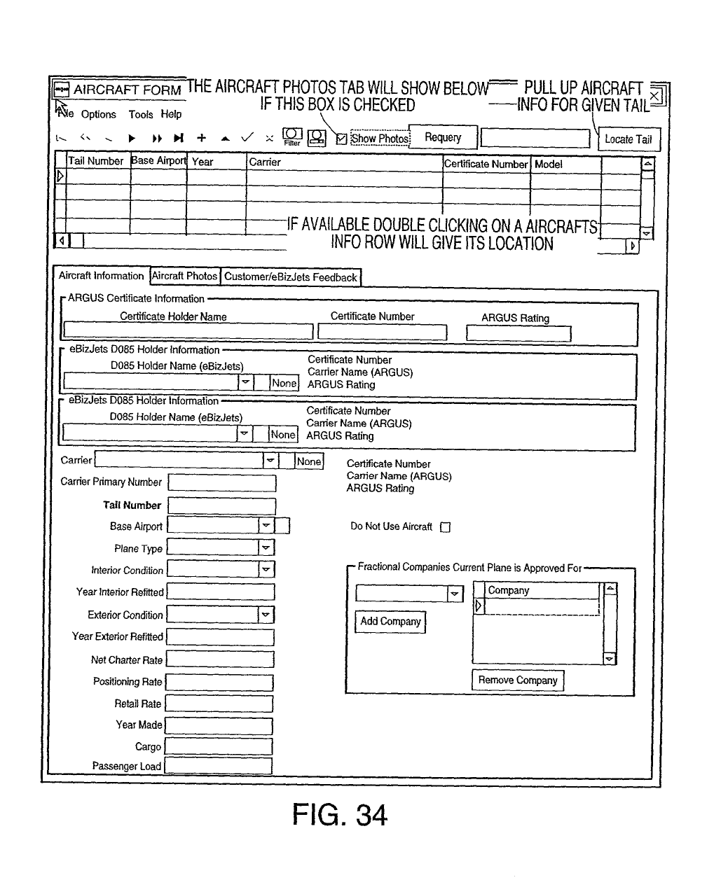

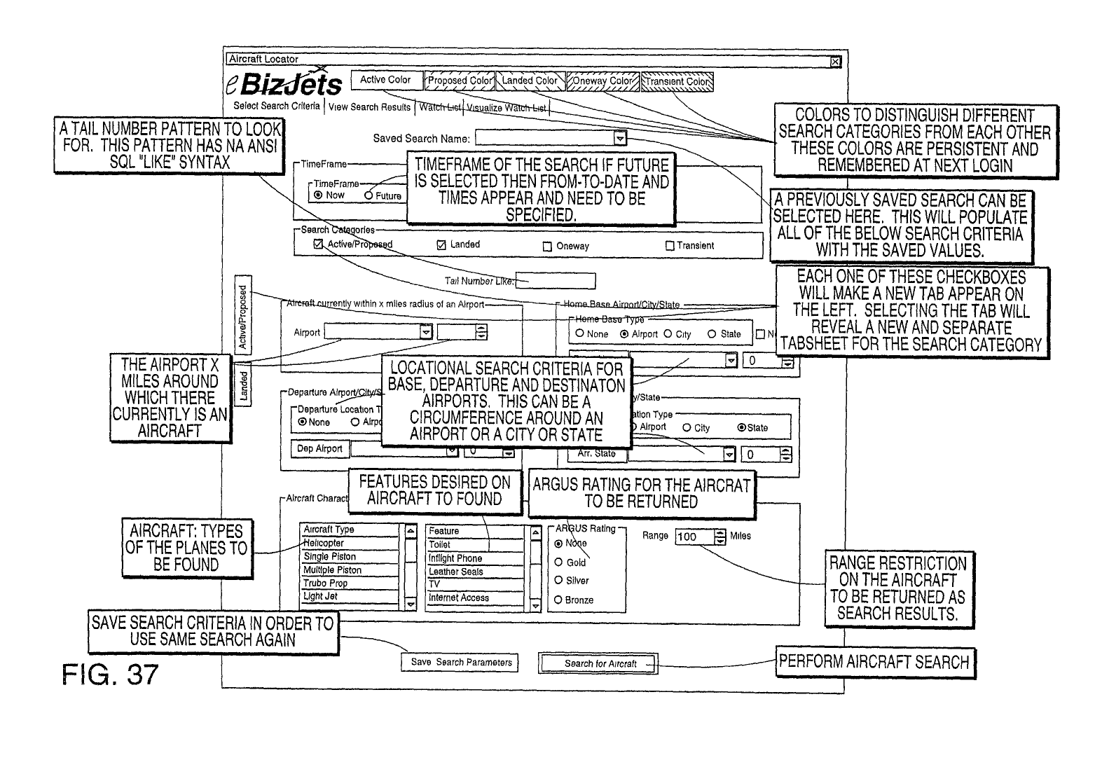

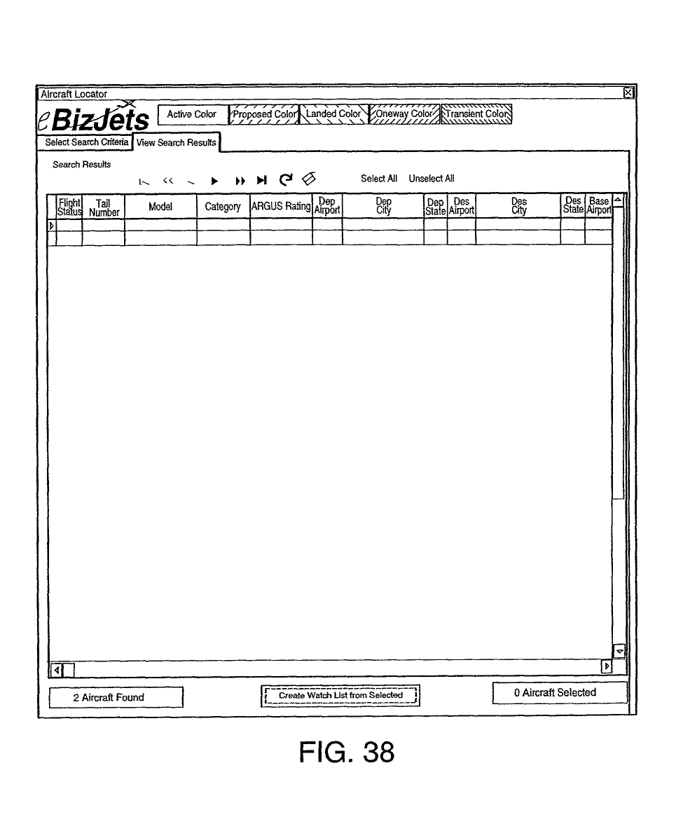

FIGS. 34-36 are illustrations showing interfaces by which a user may input to the database information related to an aircraft, including a picture of the aircraft and customer or contractor personnel feedback concerning the aircraft. FIG. 37 is an illustration showing an aircraft search interface by which a user may access a search and notification module associated with the flight command module and find an aircraft by city, state, country, phone number, or aircraft service provider name. The interface also provides electronic links to an aircraft information page that includes detailed information about that aircraft. The aircraft information page is created using the interface shown in FIG. 34. FIG. 38 shows an interface by which a user may view aircraft search results. Again, by clicking on any row, the user will gain access to more detailed information regarding the aircraft and flight.

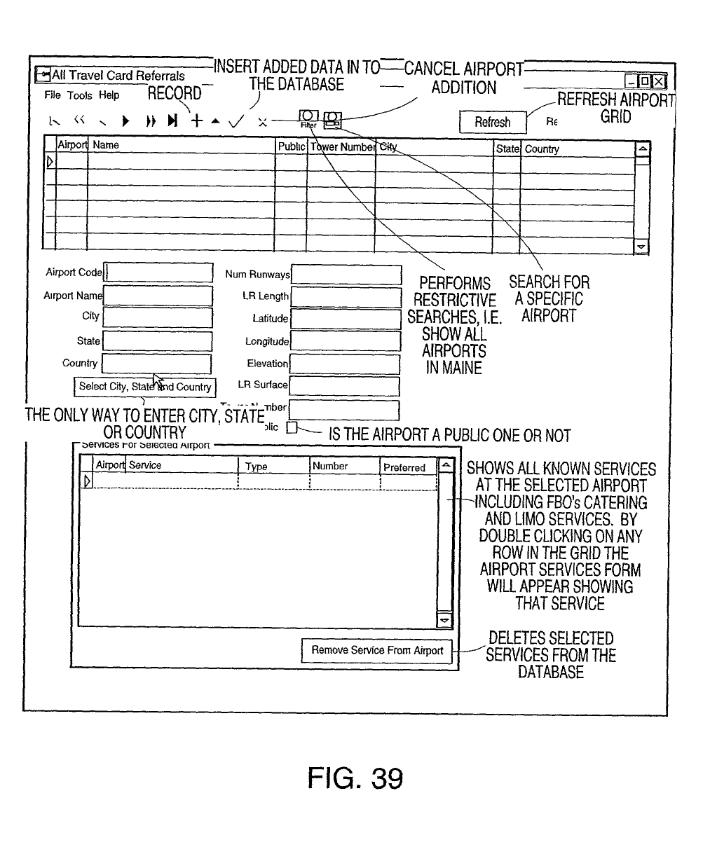

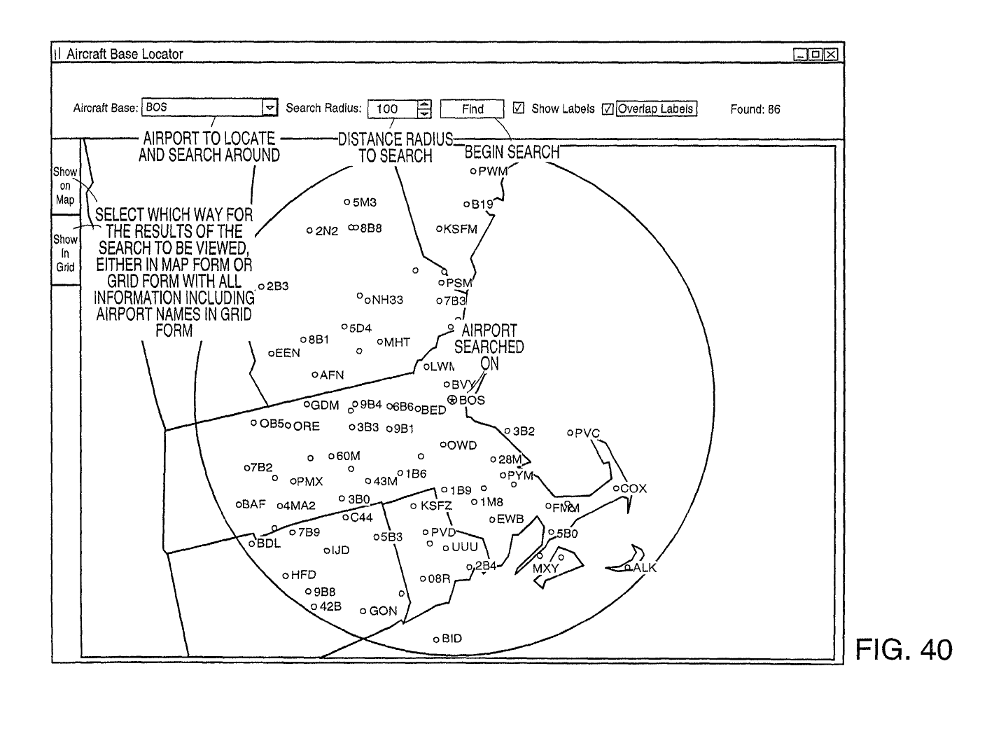

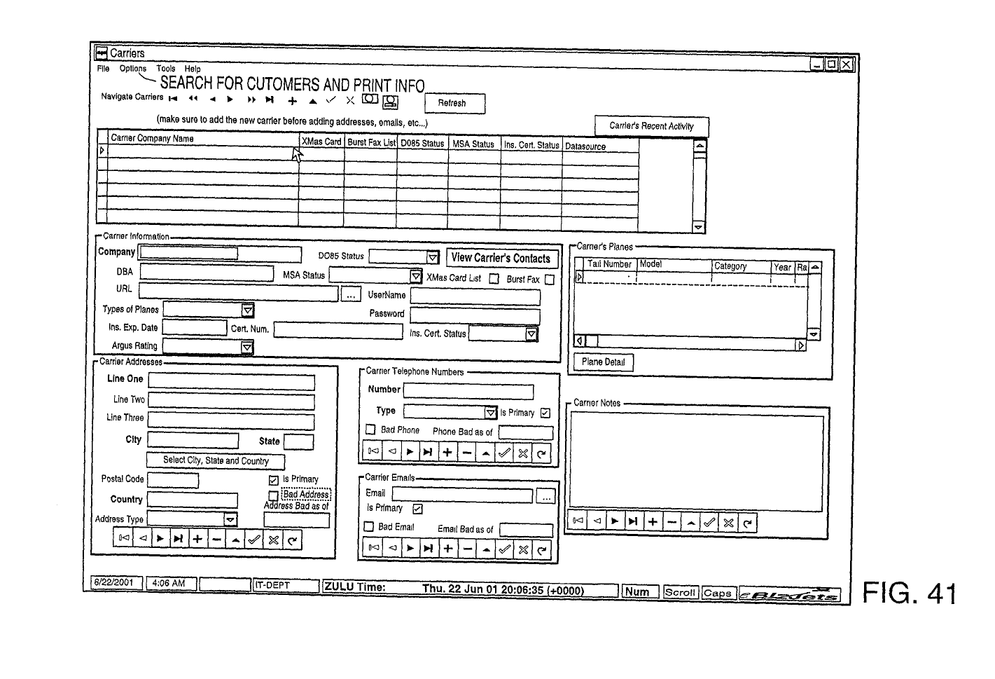

FIG. 39 is an illustration showing an airport information interface by which a user may input to the database information related to an airport. A user may also view the information related to an airport, including all the known travel services associated with an airport. FIG. 40 is an illustration showing an airport locator interface by which a user may view airport information input to the database in accordance with a map display.

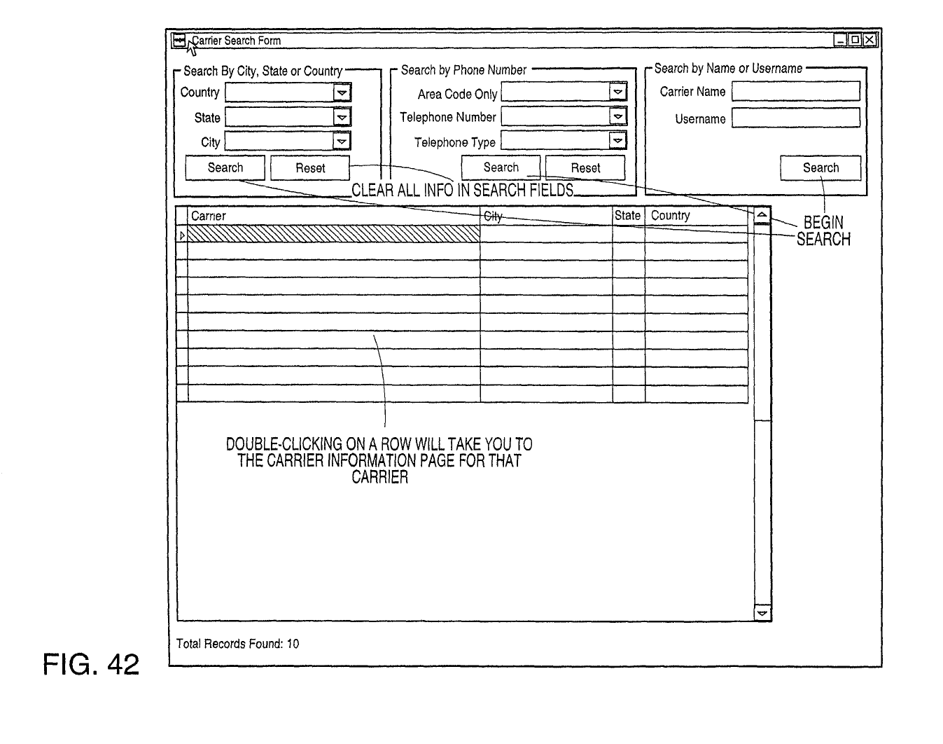

FIG. 41 is an illustration of an interface by which a user may input and edit information related to an aircraft service provider, including the aircraft service provider's name or company name, address and phone number, as well as types of planes the aircraft service provider can provide. A user may also record notes about an aircraft service provider through the interface of FIG. 41, and view the aircraft service provider's ARGUS rating, certification status and certification number. A user may also view information regarding pilots employed or contracted by the aircraft service provider. FIG. 42 shows an aircraft service provider search interface by which a user may search for a carrier by name, city, state, country, or phone number. Search results are also displayed to the user via the interface of FIG. 42, and as was the case with respect to the customer and aircraft search interfaces, double clicking on any row of the search result display will give the user access to the aircraft service provider information interface of FIG. 41 for more detailed information.

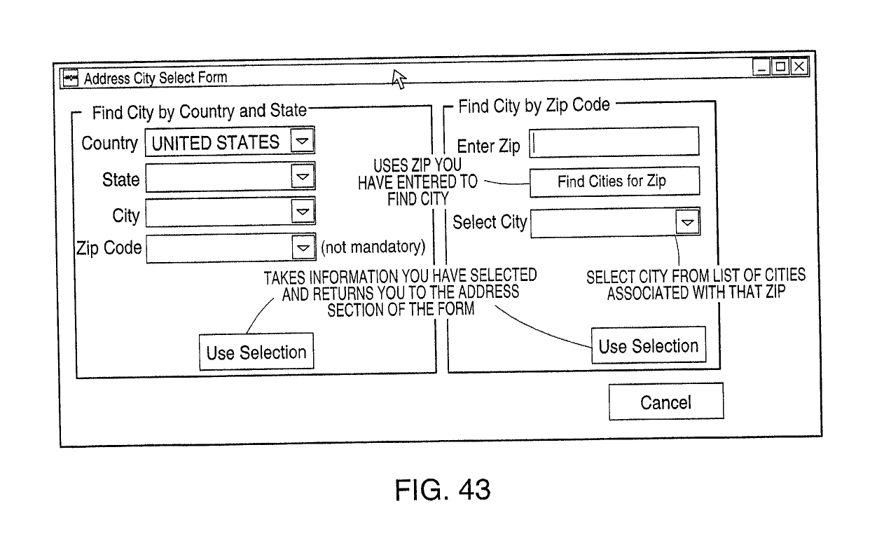

FIG. 43 is an illustration showing an address/city selection interface by which a user may find a city, country, or state by name or zip code associated with a customer, carrier, airport or aircraft.

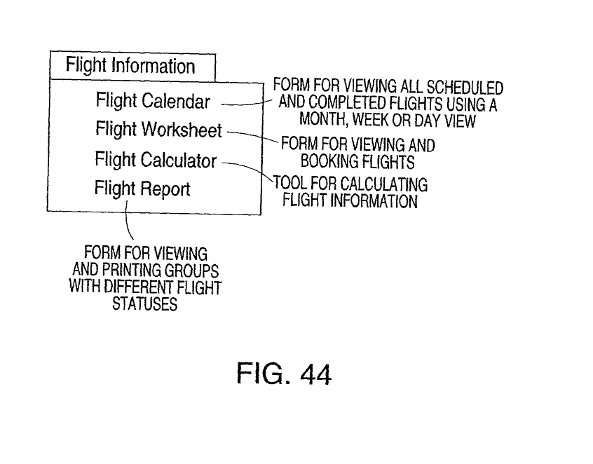

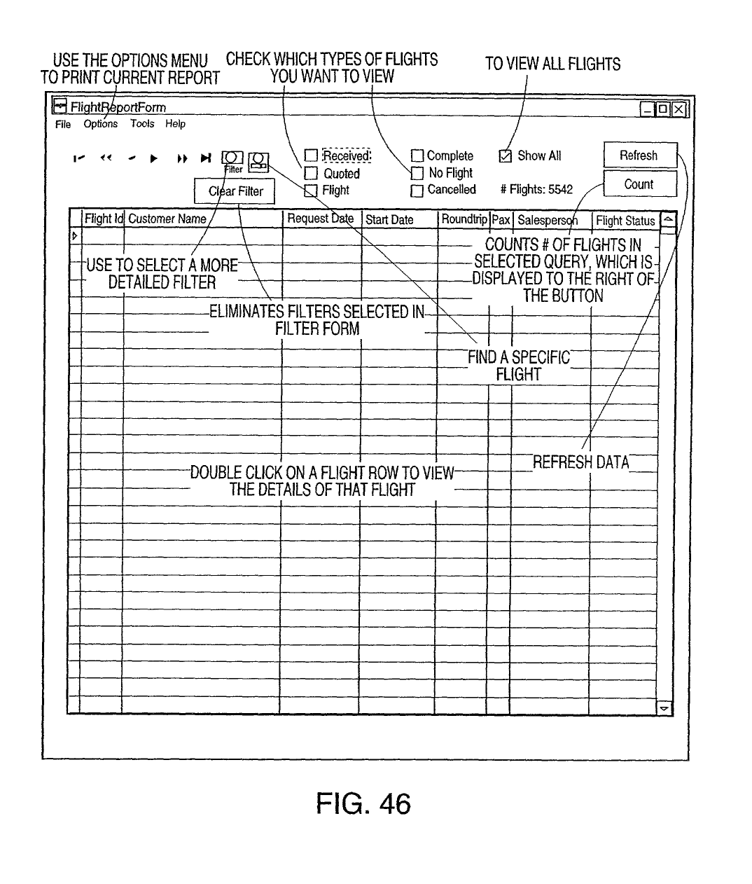

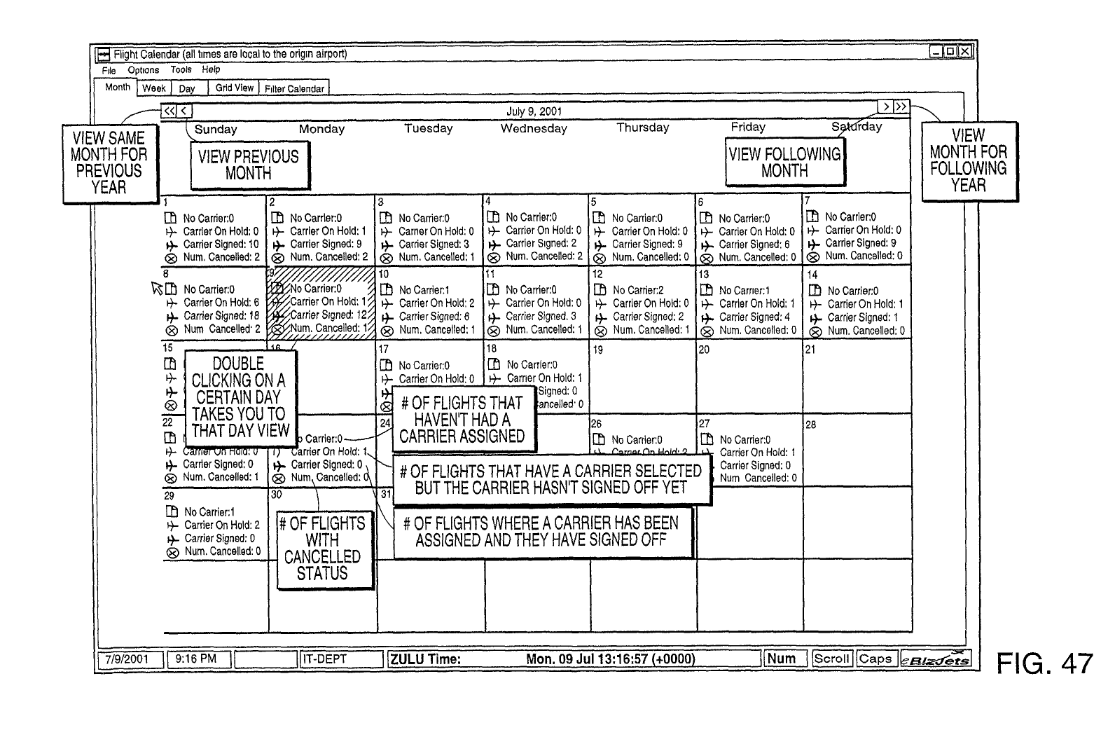

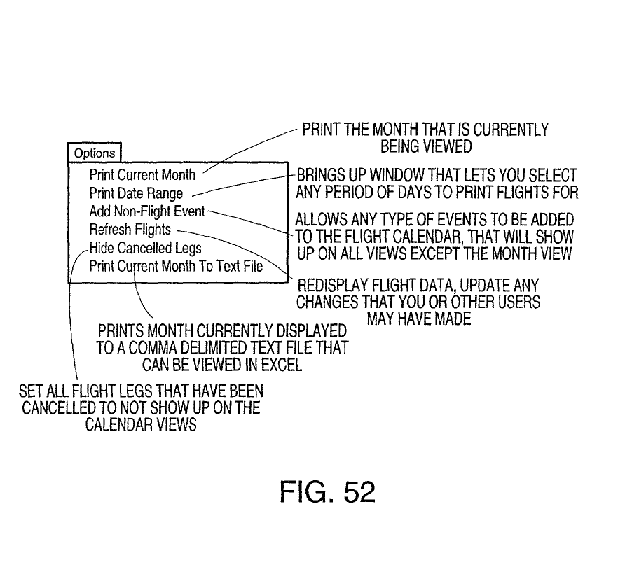

FIG. 44 is an illustration of a flight information pull down menu associated with the interface of FIG. 18. Via this pull down menu, a user may gain access to a flight calender, as shown in FIGS. 47-50, a flight worksheet for recording and editing flight information, as shown in FIG. 45, a flight calculator, or a flight report as shown in FIG. 46. Via the flight report interface of FIG. 46, a user may view all flight requests received, quoted, in progress, completed, and canceled including the flight ID, request date, flight start date, and name of the contractor employee that recorded the request. Double clicking on any field will electronically link the user to an interface whereby the user may view and modify the details of the flight (such as the through the flight worksheet interface shown in FIG. 45.) FIGS. 47-50 are illustrations showing month, day, grid and week views of a flight calendar interface respectively. By double clicking on any entry in the flight calender, a user will gain access to an interface containing more detailed information about that flight or flight leg. FIG. 51 is an illustration showing a flight calendar filter interface by which a user may filtering the flight legs shown in the month, day, grid and week views. FIG. 52 illustrates an option menu by which a user may print views of the calendar, hide flight legs so that they will not be seen in a calendar view, refresh the calendar to show recently added or modified flights, and add non-flight events to the calendar.

Although the embodiments hereinbefore described are preferred, many modifications and refinements which do not depart from the true spirit and scope of the invention may be conceived by those skilled in the art. It is intended that all such modifications, including but not limited to those set forth above, be covered by the following claims.

What is claimed is:

1. A method for providing private air travel to a customer, the method comprising:
establishing a pool of aircraft service providers;
obtaining aircraft service requests from a plurality of customers, each aircraft service request containing a set of customer-specified parameters;
selecting from the pool of aircraft service providers one or more aircraft that conform to each set of customer-specified parameters; and
matching aircraft to the aircraft service requests in accordance with the customer-specified parameters in a manner that minimizes the occurrence of passenger-less flights.

2. A method according to claim 1, further comprising receiving confirmation from an aircraft service carrier of the availability of aircraft for the aircraft service request.

3. A method according to claim 1, wherein the aircraft service requests are obtained through a web page.

4. A method according to claim 1, further comprising providing a travel card to one or more of the customers wherein the travel card represents pre-purchased amount of private aircraft service.

5. A method according to claim 4, wherein the travel card provides access to a private air travel contractor.

6. A method according to claim 1, further comprising responding to an aircraft service request within a guaranteed time interval.

7. A travel card for providing private air travel to a customer, the travel card comprising a first face and a second face, the first face including thereon an identification number for identifying a customer authorized to use the travel card and a designation representing a pre-purchased allotment of private aircraft service.

8. A travel card according to claim 7, wherein the first face or the second face includes thereon a designation representing a pre-determined number of private aircraft service flight upgrades that are redeemable at the option of the customer.

9. A travel card according to claim 7, wherein the first face or the second face includes thereon a magnetic strip that enables the card to be read by a magnetic strip reader.

10. A travel card according to claim 7, further comprising a processor and a memory disposed between the first face and the second face.

11. A travel card according to claim 10, wherein the memory retains data pertinent to the customer's private aircraft service preferences.

12. A travel card according to claim 10, wherein the memory retains data pertinent to the customer's medical preferences.

13. A travel card according to claim 10, wherein the memory retains data pertinent to the customer's medical conditions.

14. A travel card according to claim 11, wherein the data includes a record of the customer's entertainment preferences.

15. A travel card according to claim 11, wherein the data includes a record of the customer's dining preferences.

16. A travel card according to claim 10, wherein the memory retains data pertinent to the customer's post-flight travel preferences.

17. A travel card according to claim 10, wherein the memory retains data pertinent to the customer's pre-flight travel preferences.

18. A travel card according to claim 10, wherein the processor includes program code for establishing a communication link to a computer network when the program code is read by a computer.

19. A travel card according to claim 18, wherein the network is the Internet.

20. A travel card according to claim 18, wherein the network provides a communication link to a private air travel contractor.

21. A graphical user interface for providing private air travel to a customer, the graphical user interface comprising:
a request module, the request module providing a request interface containing fields for the customer to enter private aircraft travel request information;
a selection module, the selection module providing a selection interface for displaying to the customer information regarding availability of aircraft satisfying the customer's travel requests information and permitting the customer to select an aircraft; and
a payment module, the payment module providing a payment interface containing fields for the customer to enter private aircraft travel payment information.

22. A graphical user interface according to claim 21, further comprising:
a tracking module, the tracking module providing a tracking interface for displaying information regarding a flight status to the customer.

23. A graphical user interface according to claim 21, further comprising:
an account module, the account module providing an account interface for displaying information relevant to the private air travel customer's personal account.

24. A graphical user interface according to claim 21, wherein the payment interface contains a field for entering a payment method.

25. A graphical user interface according to claim 21, wherein the payment interface contains a field for entering a credit card number.

26. A graphical user interface according to claim 21, wherein the payment interface contains a field for entering a travel card number.

27. A graphical user interface according to claim 21, wherein the payment interface contains a field for entering a checking account number and a field for entering a check number.

28. A graphical user interface according to claim 23, wherein the account interface displays an account balance.

29. A graphical user interface according to claim 23, wherein the account interface displays an itemization of account activity.

30. A graphical user interface according to claim 21, wherein the selection interface displays a selection of aircraft.

31. A graphical user interface according to claim 21, wherein the selection interface displays a selection of flight times.

32. A graphical user interface according to claim 21, wherein the graphical user interface is accessed through a web page.

33. A graphical user interface for providing private air travel to a plurality of customer, the graphical user interface comprising:
a search module, the search module providing an interface whereby a user may locate, in substantially real time, an aircraft that satisfies travel requirements of each customer; and
a tracking module, the tracking module providing an interface whereby the user may track the flight progress of one or more aircraft that may satisfy travel requirements of each customer.

34. A graphical user interface according to claim 33, wherein the tracking module displays information related to an aircraft's registration number.

35. A graphical user interface according to claim 33, wherein the tracking module displays information regarding an aircraft's speed.

36. A graphical user interface according to claim 33, wherein the tracking module displays information regarding an aircraft's make and model.

37. A graphical user interface according to claim 33, wherein the tracking module displays information regarding an aircraft's altitude.

38. A graphical user interface according to claim 33, wherein the tracking interface displays information regarding an aircraft's position.

39. A graphical user interface according to claim 33, wherein the tracking interface displays information regarding an aircraft's destination.

40. A graphical user interface according to claim 33, wherein the tracking interface displays information regarding an aircraft's estimated time of arrival.

41. A graphical user interface according to claim 33, wherein the tracking interface displays information regarding an aircraft's origin.

42. A graphical user interface according to claim 33, wherein the tracking interface displays a location of at least one airport at which the aircraft may land.

43. A graphical user interface according to claim 33, further comprising:
a flight entry module, the flight entry module providing an interface containing fields whereby the user may create a flight for each customer, the flight entry module generating an interface for displaying a calender of updated flights in accordance with the entry of each flight created.

44. A graphical user interface according to claim 33, further comprising:
a flight information module, the flight information module providing an interface for displaying to the user information regarding aircraft availability.

45. A graphical user interface according to claim 33, further comprising:
a payment module, the payment module providing a payment interface containing fields whereby the user may enter customer payment information.

46. A graphical user interface according to claim 33, further comprising:
a report module, the report module providing an interface whereby a user may generate a flight report.

47. A graphical user interface according to claim 33, wherein the tracking module provides an interface wherein a user may create a watch list for tracking one or more aircraft.

48. A system for providing private air travel to a customer, the system comprising:
means for communicating with a plurality of aircraft service providers, the aircraft service providers supplying a plurality of aircraft types from a plurality of locations; and
means for communicating with a plurality of customers, each of the customers providing an itinerary for private air travel, such that at least one aircraft from the plurality of aircraft service providers is matched to the itinerary in a manner that minimizes the occurrence of passenger-less flights.

49. A system according to claim 48, further comprising means for communicating with a database, the database providing, under corresponding program control:
data pertinent to active flights;
data pertinent to proposed flights;
data pertinent to landed flights;
data pertinent to one-way flights; and
data pertinent to transient flights.

50. A system according to claim 49, wherein the database further provides:
data pertinent to aircraft types;
data pertinent to aircraft safety;

51. A system according to claim 49, wherein the database further provides:
data pertinent to aircraft service providers; and
data pertinent to aircraft service provider safety.

52. A system according to claim 49, wherein the database further provides:
data pertinent to pilot safety histories;
data pertinent to pilot training histories.

53. A system according to claim 49, wherein the database further provides data pertinent to travel service providers.

54. A system according to claim 49, wherein the database further provides data pertinent to each of the customers.

55. A system according to claim 48, further comprising means for communicating with at least one satellite dish, the satellite dish providing data to the database.

56. A system according to claim 48, further comprising means for communicating with a network, the network providing data to the database.

57. A system according to claim 48, wherein the means for communicating with the plurality of customers includes means for communicating with one or more travel cards, each travel card having a processor and a memory.

58. A system according to claim 57, wherein each travel card provides access to a plurality of car rental services.

59. A system according to claim 57, wherein each travel card provides access to a plurality of innkeepers.

60. A computer program product for providing a database for providing private air travel to a customer, the computer program product comprising a computer readable medium having computer code thereon, the computer code comprising:
program code for receiving data regarding aircraft provided by at least one satellite dish and at least one computer network; and
program code for storing the data provided by the satellite dish and the computer network.

61. A computer program product according to claim 60, further comprising:
program code for establishing communication with a plurality of aircraft service providers and receiving data from the aircraft service providers; and
program code for establishing communication with a plurality of customers and receiving data from each of the customers such that data received from each customer may be compared to data received from the aircraft service providers, the satellite dish and the network to provide a flight to each customer.

62. A computer program product according to claim 60, further comprising program code for comparing the data stored in the database with the data received from the satellite dish, the computer network, the aircraft service providers and the customers in order to update the database.

63. A computer program product according to claim 60, further comprising program code for providing an graphical user interface by which a user may provide private air travel to each customer, the interface providing an electronic link to:
a module for recording information corresponding to each customer's flight preferences;
a module for enabling the user to search for an aircraft satisfying the customer's flight preferences; and
a module for enabling the user to search for an airport satisfying each customer's flight preferences.

64. A computer program product according to claim 63, wherein the interface further provides an electronic link to a module for enabling the user to record each customer's catering preferences.

65. A computer program product according to claim 63, wherein the interface further provides an electronic link to:
a module for accessing and editing each customer's records;
a module for accessing and editing a plurality of aircraft service provider's records, wherein each aircraft service provider provides one or more aircraft; and
a module for accessing and editing aircraft records.

66. A computer program product according to claim 63, wherein the interface further provides and electronic link to a module that provides a geographical view of a location of an aircraft.

67. A computer program product according to claim 63, wherein the interface further provides an electronic link to a module that provides a geographical view of a location of an airport.

68. A computer program product according to claim 63, further comprising program code for tracking the course of an aircraft over time.

69. A computer program product according to claim 63, further comprising program code for providing a graphical user interface by which a user may input criteria corresponding to a tracking request.

70. A computer program product according to claim 63, further comprising program code for providing a graphical user interface by which each customer may enter a private air travel request.

71. A method for providing private air travel to a plurality of customers, the method comprising:
receiving data relevant to a plurality of aircraft owned by a plurality of aircraft service providers, via a first communication link;
receiving data relevant to a plurality of customer service requests via a second communication link;
saving the data received from the first and second communication links to a storage medium;
analyzing the data saved to match at least one aircraft to each customer service request in a manner that minimizes the occurrence of passenger-less flights.

72. A method according to claim 71, wherein the data relevant to the plurality of aircraft is received substantially in real time.

73. A method according to claim 71, wherein the data relevant to the plurality of aircraft is received from a satellite dish.

74. A method according to claim 71, wherein the data relevant to the plurality of aircraft is received from a computer network.

75. A method according to claim 71, wherein the storage medium is a database that, under corresponding program control, analyzes the data saved to match at least one aircraft to each customer service request in a manner that minimizes the occurrence of passenger-less flights.

76. A method for providing travel services including private air travel to a plurality of customers, the method comprising:
providing a pre-purchased allotment of private air travel to one or more of the customers;
receiving a travel service request from each customer, the travel service request including customer-specified flight parameters;
providing an aircraft that satisfies the customer-specified flight parameters for each customer's travel service; and
debiting the value of the travel service from the pre-purchased allotment of private air travel for each customer that is provided with the pre-purchased allotment.

77. A method according to claim 76, wherein providing a pre-purchased allotment of private air travel includes providing a travel card to a customer, the travel card having a first face and a second face, wherein the first or second face includes thereon a designation indicating the pre-purchased allotment of private air travel.

78. A method according to claim 76, wherein providing a pre-purchased allotment of private air travel includes providing a pre-determined number of flight upgrades that are redeemable at the option of the customer.

79. A method according to claim 76, wherein providing a pre-purchased allotment of private air travel includes providing a pre-determined number of frequent flyer upgrades that are redeemable at the option of the customer.

80. A method according to claim 76, wherein providing a pre-purchased allotment of private air travel includes providing a dedicated customer service representative.

81. A method according to claim 77, wherein the first or second face of the travel card includes thereon a designation indicating a pre-determined number of flight upgrades that are redeemable at the option of the customer.

82. A method according to claim 77, where the first or second face of the travel card includes thereon a designation indicating a pre-determined number of frequent flyer upgrades that are redeemable at the option of the customer.

83. A method according to claim 77, wherein the first of second face of the travel card includes thereon a designation indicating identification of a dedicated customer service representative.
